(19) United States
(12) Patent Application Publication
(10) Pub. No.: US 2026/0012642 A1
(43) Pub. Date: Jan. 8, 2026

(54) METHOD, APPARATUS, AND MEDIUM FOR VISUAL DATA PROCESSING

(71) Applicants: Douyin Vision Co., Ltd., Beijing (CN); Bytedance Inc., Los Angeles, CA (US)

(72) Inventors: Ke MA, Beijing (CN); Yaojun WU, Beijing (CN); Zhaobin ZHANG, Los Angeles, CA (US); Semih ESENLIK, Los Angeles, CA (US); Kai ZHANG, Los Angeles, CA (US); Li ZHANG, Los Angeles, CA (US)

(21) Appl. No.: 19/325,000

(22) Filed: Sep. 10, 2025

Related U.S. Application Data
(63) Continuation of application No. PCT/CN2024/080828, filed on Mar. 8, 2024.

(30) Foreign Application Priority Data
Mar. 10, 2023 (WO) PCT/CN2023/080645
Sep. 25, 2023 (WO) PCT/CN2023/121238

(51) Int. Cl. H04N 19/63; H04N 19/119; H04N 19/13; H04N 19/132; H04N 19/176; H04N 19/42

(52) U.S. Cl. CPC H04N 19/63; H04N 19/119; H04N 19/13; H04N 19/132; H04N 19/176; H04N 19/42

(57) ABSTRACT

A mechanism for processing video data is disclosed. The method includes: determining, for a conversion between a visual data and a bitstream of the visual data, a wavelet-based transform module and a resizing operation; and performing the conversion based on the wavelet-based transform module and the resizing operation.

### CROSS REFERENCE

This application is a continuation of International Application No. PCT/CN2024/080828, filed on Mar. 8, 2024, which claims the benefit of International Application No. PCT/CN2023/080645, filed on Mar. 10, 2023 and International Application No. PCT/CN2023/121238, filed on Sep. 25, 2023. The entire contents of these applications are hereby incorporated by reference in their entireties.

### TECHNICAL FIELD

Embodiments of the present disclosure relates generally to visual data processing techniques, and more particularly, to a learning-based decorrelation method with the combination of wavelet-like and non-linear transformation for image compression.

### BACKGROUND

The past decade has witnessed the rapid development of deep learning in a variety of areas, especially in computer vision and image processing. Neural network was invented originally with the interdisciplinary research of neuroscience and mathematics. It has shown strong capabilities in the context of non-linear transform and classification. Neural network-based image/video compression technology has gained significant progress during the past half decade. It is reported that the latest neural network-based image compression algorithm achieves comparable rate-distortion (R-D) performance with Versatile Video Coding (VVC). With the performance of neural image compression continually being improved, neural network-based video compression has become an actively developing research area. However, coding quality and coding efficiency of neural network-based image/video coding is generally expected to be further improved.

### SUMMARY

Embodiments of the present disclosure provide a solution for visual data processing.

In a first aspect, a method for visual data processing is proposed. The method comprises: determining, for a conversion between a visual data and a bitstream of the visual data, a wavelet-based transform module and a resizing operation; and performing the conversion based on the wavelet-based transform module and the resizing operation.

In a second aspect, an apparatus for visual data processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of visual data which is generated by a method performed by an apparatus for visual data processing. The method comprises: determining a wavelet-based transform module and a resizing operation; and generating the bitstream based on the wavelet-based transform module and the resizing operation.

In a fifth aspect, a method for storing a bitstream of visual data is proposed. The method comprises: determining a wavelet-based transform module and a resizing operation; generating the bitstream based on the wavelet-based transform module and the resizing operation; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example visual data coding system, in accordance with some embodiments of the present disclosure;

FIG. 2 is a schematic diagram illustrating an example transform coding scheme;

FIG. 3 illustrates example latent representations of an image;

FIG. 4 is a schematic diagram illustrating an example autoencoder implementing a hyperprior model;

FIG. 5 is a schematic diagram illustrating an example combined model configured to jointly optimize a context model along with a hyperprior and the autoencoder;

FIG. 6 illustrates an example encoding process;

FIG. 7 illustrates an example decoding process;

FIG. 8 illustrates an example encoder and decoder with wavelet-based transform;

FIG. 9 illustrates an example output of a forward wavelet-based transform;

FIG. 10 illustrates an example partitioning of the output of a forward wavelet-based transform;

FIG. 11 illustrates an example encoding process;

FIG. 12 illustrates an example downsampling network architecture used to unify the spatial sizes of the sub-bands;

FIG. 13 illustrates an example of non-linear merging and decorrelation;

FIG. 14 illustrates an example decoding process;

FIG. 15 illustrates an example upsampling network architecture;

FIG. 16 illustrates an example of non-linear up-transformation;

FIG. 17 illustrates an example of the encoding process;

FIG. 18 illustrates an example of the upsampling network architectures used to unifying the spatial sizes of the sub-bands;

FIG. 19 illustrates non-linear merging and decorrelation;

FIG. 20 illustrates an example of the decoding process;

FIG. 21 illustrates an example of the downsampling network architectures;

FIG. 22 illustrates non-linear inverse transformation;

FIG. 23 illustrates an example of sub-networks utilized in FIG. 12 to FIG. 22;

FIG. 24 illustrates a flowchart of a method for visual data processing in accordance with embodiments of the present disclosure;

FIG. 25 illustrates a block diagram of a computing device in which various embodiments of the present disclosure can be implemented.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

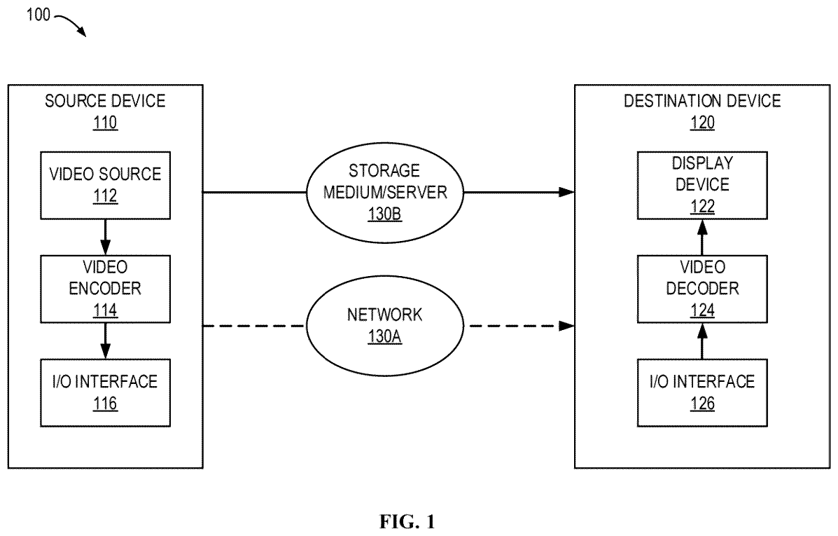

FIG. 1 is a block diagram that illustrates an example visual data coding system 100 that may utilize the techniques of this disclosure. As shown, the visual data coding system 100 may include a source device 110 and a destination device 120. The source device 110 can be also referred to as a visual data encoding device, and the destination device 120 can be also referred to as a visual data decoding device. In operation, the source device 110 can be configured to generate encoded visual data and the destination device 120 can be configured to decode the encoded visual data generated by the source device 110. The source device 110 may include a visual data source 112, a visual data encoder 114, and an input/output (I/O) interface 116.

The visual data source 112 may include a source such as a visual data capture device. Examples of the visual data capture device include, but are not limited to, an interface to receive visual data from a visual data provider, a computer graphics system for generating visual data, and/or a combination thereof.

The visual data may comprise one or more pictures of a video or one or more images. The visual data encoder 114 encodes the visual data from the visual data source 112 to generate a bitstream. The bitstream may include a sequence of bits that form a coded representation of the visual data. The bitstream may include coded pictures and associated visual data. The coded picture is a coded representation of a picture. The associated visual data may include sequence parameter sets, picture parameter sets, and other syntax structures. The I/O interface 116 may include a modulator/demodulator and/or a transmitter. The encoded visual data may be transmitted directly to destination device 120 via the I/O interface 116 through the network 130A. The encoded visual data may also be stored onto a storage medium/server 130B for access by destination device 120.

The destination device 120 may include an I/O interface 126, a visual data decoder 124, and a display device 122. The I/O interface 126 may include a receiver and/or a modem. The I/O interface 126 may acquire encoded visual data from the source device 110 or the storage medium/server 130B. The visual data decoder 124 may decode the encoded visual data. The display device 122 may display the decoded visual data to a user. The display device 122 may be integrated with the destination device 120, or may be external to the destination device 120 which is configured to interface with an external display device.

The visual data encoder 114 and the visual data decoder 124 may operate according to a visual data coding standard, such as video coding standard or still picture coding standard and other current and/or further standards.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific visual data codecs, the disclosed techniques are applicable to other coding technologies also. Furthermore, while some embodiments describe coding steps in detail, it will be understood that corresponding steps decoding that undo the coding will be implemented by a decoder. Furthermore, the term visual data processing encompasses visual data coding or compression, visual data decoding or decompression and visual data transcoding in which visual data are represented from one compressed format into another compressed format or at a different compressed bitrate.

### 1. Initial Discussion

The present disclosure is related to a neural network-based image and video compression approach, wherein a wavelet-like transform and non-linear transformation are combined to boost coding efficiency. The examples target the problem of processing subbands of different spatial resolution after wavelet transformation by aiming to resize the subbands and remove the correlation between each subband.

### 2. Further Discussion

Deep learning is developing in a variety of areas, such as in computer vision and image processing. Inspired by the successful application of deep learning technology to computer vision areas, neural image/video compression technologies are being studied for application to image/video compression techniques. The neural network is designed based on interdisciplinary research of neuroscience and mathematics. The neural network has shown strong capabilities in the context of non-linear transform and classification. An example neural network-based image compression algorithm achieves comparable R-D performance with Versatile Video Coding (VVC), which is a video coding standard developed by the Joint Video Experts Team (JVET) with experts from motion picture experts group (MPEG) and Video coding experts group (VCEG). Neural network-based video compression is an actively developing research area resulting in continuous improvement of the performance of neural image compression. However, neural network-based video coding is still a largely undeveloped discipline due to the inherent difficulty of the problems addressed by neural networks.

### 2.1 Image/Video Compression

Image/video compression usually refers to a computing technology that compresses video images into binary code to facilitate storage and transmission. The binary codes may or may not support losslessly reconstructing the original image/video. Coding without data loss is known as lossless compression and coding while allowing for targeted loss of data in known as lossy compression, respectively. Most coding systems employ lossy compression since lossless reconstruction is not necessary in most scenarios. Usually the performance of image/video compression algorithms is evaluated based on a resulting compression ratio and reconstruction quality. Compression ratio is directly related to the number of binary codes resulting from compression, with fewer binary codes resulting in better compression. Reconstruction quality is measured by comparing the reconstructed image/video with the original image/video, with greater similarity resulting in better reconstruction quality.

Image/video compression techniques can be divided into video coding methods and neural-network-based video compression methods. Video coding schemes adopt transform-based solutions, in which statistical dependency in latent variables, such as discrete cosine transform (DCT) and wavelet coefficients, is employed to carefully hand-engineer entropy codes to model the dependencies in the quantized regime. Neural network-based video compression can be grouped into neural network-based coding tools and end-to-end neural network-based video compression. The former is embedded into existing video codecs as coding tools and only serves as part of the framework, while the latter is a separate framework developed based on neural networks without depending on video codecs.

A series of video coding standards have been developed to accommodate the increasing demands of visual content transmission. The international organization for standardization (ISO)/International Electrotechnical Commission (IEC) has two expert groups, namely Joint Photographic Experts Group (JPEG) and Moving Picture Experts Group (MPEG). International Telecommunication Union (ITU) telecommunication standardization sector (ITU-T) also has a Video Coding Experts Group (VCEG), which is for standardization of image/video coding technology. The influential video coding standards published by these organizations include Joint Photographic Experts Group (JPEG), JPEG 2000, H.262, H.264/advanced video coding (AVC) and H.265/High Efficiency Video Coding (HEVC). The Joint Video Experts Team (JVET), formed by MPEG and VCEG, developed the Versatile Video Coding (VVC) standard. An average of 50% bitrate reduction is reported by VVC under the same visual quality compared with HEVC.

Neural network-based image/video compression/coding is also under development. Example neural network coding network architectures are relatively shallow, and the performance of such networks is not satisfactory. Neural network-based methods benefit from the abundance of data and the support of powerful computing resources, and are therefore better exploited in a variety of applications. Neural network-based image/video compression has shown promising improvements and is confirmed to be feasible. Nevertheless, this technology is far from mature and a lot of challenges should be addressed.

### 2.2 Neural Networks

Neural networks, also known as artificial neural networks (ANN), are computational models used in machine learning technology. Neural networks are usually composed of multiple processing layers, and each layer is composed of multiple simple but non-linear basic computational units. One benefit of such deep networks is a capacity for processing data with multiple levels of abstraction and converting data into different kinds of representations. Representations created by neural networks are not manually designed. Instead, the deep network including the processing layers is learned from massive data using a general machine learning procedure. Deep learning eliminates the necessity of handcrafted representations. Thus, deep learning is regarded useful especially for processing natively unstructured data, such as acoustic and visual signals. The processing of such data has been a longstanding difficulty in the artificial intelligence field.

### 2.3 Neural Networks For Image Compression

Neural networks for image compression can be classified in two categories, including pixel probability models and auto-encoder models. Pixel probability models employ a predictive coding strategy. Auto-encoder models employ a transform-based solution. Sometimes, these two methods are combined together.

### 2.3.1 Pixel Probability Modeling

According to Shannon's information theory, the optimal method for lossless coding can reach the minimal coding rate, which is denoted as—log₂ p(x) where p(x) is the probability of symbol x. Arithmetic coding is a lossless coding method that is believed to be among the optimal methods. Given a probability distribution p(x), arithmetic coding causes the coding rate to be as close as possible to a theoretical limit—log₂ p(x) without considering the rounding error. Therefore, the remaining problem is to determine the probability, which is very challenging for natural image/video due to the curse of dimensionality. The curse of dimensionality refers to the problem that increasing dimensions causes data sets to become sparse, and hence rapidly increasing amounts of data is needed to effectively analyze and organize data as the number of dimensions increases.

Following the predictive coding strategy, one way to model p(x) is to predict pixel probabilities one by one in a raster scan order based on previous observations, where x is an image, can be expressed as follows:

$$p ( x ) = p ( {x}_{1} ) p ( {x}_{2} \vert {x}_{1} ) … p ( {x}_{i} \vert {x}_{1} , … , {x}_{i - 1} ) … p ( {x}_{m \times n} \vert {x}_{1} , … , {x}_{m \times n - 1} ) \qquad ( 1 )$$

where m and n are the height and width of the image, respectively. The previous observation is also known as the context of the current pixel. When the image is large, estimation of the conditional probability can be difficult. Thereby, a simplified method is to limit the range of the context of the current pixel as follows:

$$p ( x ) = p ( {x}_{1} ) p ( {x}_{2} \vert {x}_{1} ) … p ( {x}_{i} \vert {x}_{i - k} , … , {x}_{i - 1} ) … p ( {x}_{m \times n} \vert {x}_{m \times n - k} , … , {x}_{m \times n - 1} ) \qquad ( 2 )$$

where k is a pre-defined constant controlling the range of the context.

It should be noted that the condition may also take the sample values of other color components into consideration. For example, when coding the red (R), green (G), and blue (B) (RGB) color component, the R sample is dependent on previously coded pixels (including R,G, and/or B samples), the current G sample may be coded according to previously coded pixels and the current R sample. Further, when coding the current B sample, the previously coded pixels and the current R and G samples may also be taken into consideration.

Neural networks may be designed for computer vision tasks, and may also be effective in regression and classification problems. Therefore, neural networks may be used to estimate the probability of p(xᵢ) given a context x₁, x₂, . . . , xᵢ₋₁.

Most of the methods directly model the probability distribution in the pixel domain. Some designs also model the probability distribution as conditional based upon explicit or latent representations. Such a model can be expressed as:

$$p ( x \vert h ) = {\prod }_{i = 1}^{m \times n} p ( {x}_{i} \vert {x}_{1} , … , {x}_{i - 1} , h ) \qquad ( 3 )$$

where h is the additional condition and p(x)=p(h)p(x|h) indicates the modeling is split into an unconditional model and a conditional model. The additional condition can be image label information or high-level representations.

### 2.3.2 Auto-Encoder

An Auto-encoder is now described. The auto-encoder is trained for dimensionality reduction and include an encoding component and a decoding component. The encoding component converts the high-dimension input signal to low-dimension representations. The low-dimension representations may have reduced spatial size, but a greater number of channels. The decoding component recovers the high-dimension input from the low-dimension representation. The auto-encoder enables automated learning of representations and eliminates the need of hand-crafted features, which is also believed to be one of the most important advantages of neural networks.

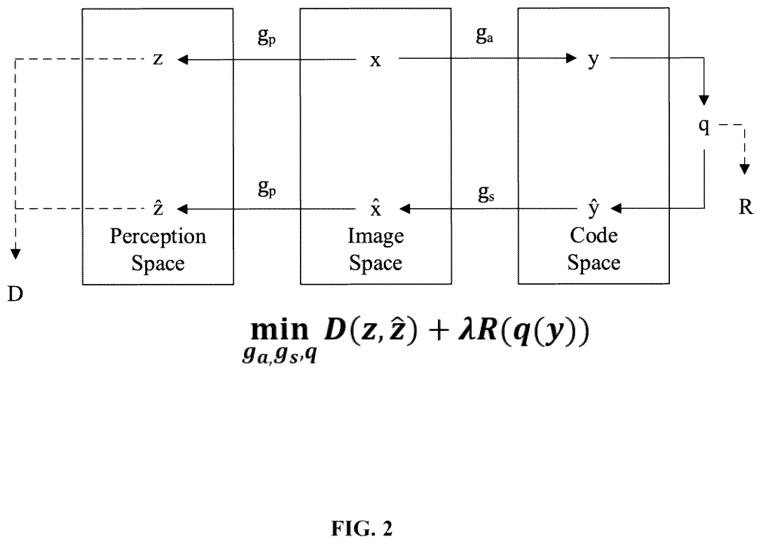

FIG. 2 is a schematic diagram illustrating an example transform coding scheme. The original image x is transformed by the analysis network gₐ to achieve the latent representation y. The latent representation y is quantized (q) and compressed into bits. The number of bits R is used to measure the coding rate. The quantized latent representation ŷ is then inversely transformed by a synthesis network gₛ to obtain the reconstructed image \hat{x}. The distortion (D) is calculated in a perceptual space by transforming x and \hat{x} with the function gₚ, resulting in z and \hat{z}, which are compared to obtain D.

An auto-encoder network can be applied to lossy image compression. The learned latent representation can be encoded from the well-trained neural networks. However, adapting the auto-encoder to image compression is not trivial since the original auto-encoder is not optimized for compression, and is thereby not efficient for direct use as a trained auto-encoder. In addition, other major challenges exist. First, the low-dimension representation should be quantized before being encoded. However, the quantization is not differentiable, which is required in backpropagation while training the neural networks. Second, the objective under a compression scenario is different since both the distortion and the rate need to be take into consideration. Estimating the rate is challenging. Third, a practical image coding scheme should support variable rate, scalability, encoding/decoding speed, and interoperability. In response to these challenges, various schemes are under development.

An example auto-encoder for image compression using the example transform coding scheme 100 can be regarded as a transform coding strategy. The original image x is transformed with the analysis network y=gₐ(x), where y is the latent representation to be quantized and coded. The synthesis network inversely transforms the quantized latent representation ŷ back to obtain the reconstructed image \hat{x}=gₛ (ŷ). The framework is trained with the rate-distortion loss function, £=D+λR, where D is the distortion between x and \hat{x}, R is the rate calculated or estimated from the quantized representation ŷ, and λ is the Lagrange multiplier. D can be calculated in either pixel domain or perceptual domain. Most example systems follow this prototype and the differences between such systems might only be the network structure or loss function.

### 2.3.3 Hyper Prior Model

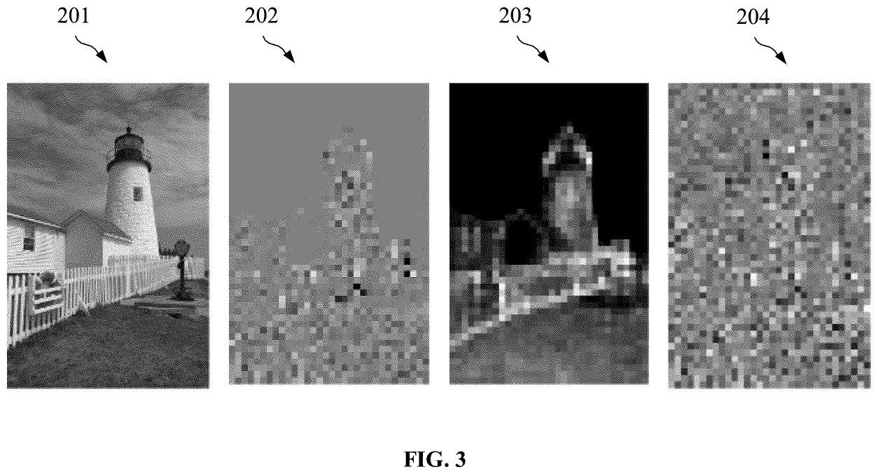

FIG. 3 illustrates example latent representations of an image. FIG. 3 includes an image 201 from the Kodak dataset, visualization of the latent 202 representation y of the image 201, a standard deviations σ 203 of the latent 202, and latents y 204 after a hyper prior network is introduced. A hyper prior network includes a hyper encoder and decoder. In the transform coding approach to image compression, as shown in FIG. 2, the encoder subnetwork transforms the image vector x using a parametric analysis transform gₐ (x, Ø_{g}) into a latent representation y, which is then quantized to form ŷ. Because ŷ is discrete-valued, ŷ can be losslessly compressed using entropy coding techniques such as arithmetic coding and transmitted as a sequence of bits.

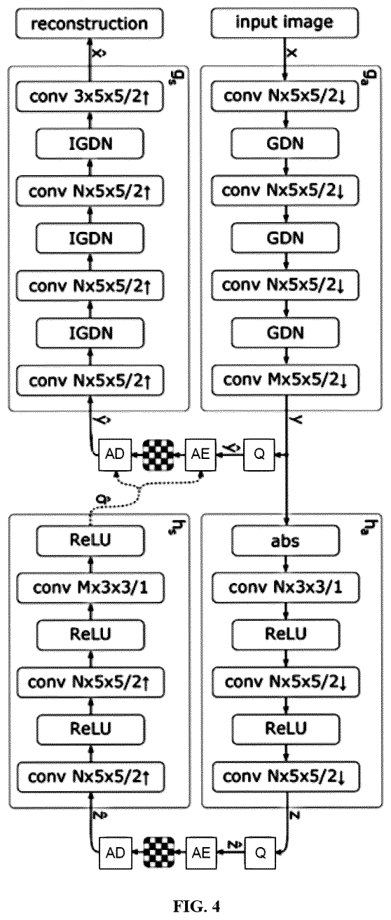

As evident from the latent 202 and the standard deviations σ 203 of FIG. 3, there are significant spatial dependencies among the elements of ŷ. Notably, their scales (standard deviations σ203) appear to be coupled spatially. An additional set of random variables \hat{z} may be introduced to capture the spatial dependencies and to further reduce the redundancies. In this case the image compression network is depicted in FIG. 4.

FIG. 4 is a schematic diagram illustrating an example network architecture of an autoencoder implementing a hyperprior model. The upper side shows an image autoencoder network, and the lower side corresponds to the hyperprior subnetwork. The analysis and synthesis transforms are denoted as gₐ and gₐ. Q represents quantization, and AE, AD represent arithmetic encoder and arithmetic decoder, respectively. The hyperprior model includes two subnetworks, hyper encoder (denoted with hₐ) and hyper decoder (denoted with hₛ). The hyper prior model generates a quantized hyper latent (\hat{z}) which comprises information related to the probability distribution of the samples of the quantized latent ŷ. \hat{z} is included in the bitstream and transmitted to the receiver (decoder) along with ŷ.

In schematic diagram in FIG. 4, the upper side of the models is the encoder gₐ and decoder gₛ as discussed above. The lower side is the additional hyper encoder hₐ and hyper decoder hₛ networks that are used to obtain \hat{z}. In this architecture the encoder subjects the input image x to gₐ, yielding the responses y with spatially varying standard deviations. The responses y are fed into hₐ, summarizing the distribution of standard deviations in z. z is then quantized (\hat{z}), compressed, and transmitted as side information. The encoder then uses the quantized vector \hat{z} to estimate σ, the spatial distribution of standard deviations, and uses σ to compress and transmit the quantized image representation ŷ. The decoder first recovers \hat{z} from the compressed signal. The decoder then uses hₛ to obtain σ, which provides the decoder with the correct probability estimates to successfully recover ŷ as well. The decoder then feeds ŷ into gₛ to obtain the reconstructed image.

When the hyper encoder and hyper decoder are added to the image compression network, the spatial redundancies of the quantized latent ŷ are reduced. The latents y 204 in FIG. 3 correspond to the quantized latent when the hyper encoder/decoder are used. Compared to the standard deviations σ203, the spatial redundancies are significantly reduced as the samples of the quantized latent are less correlated.

### 2.3.4 Context Model

Although the hyper prior model improves the modelling of the probability distribution of the quantized latent ŷ, additional improvement can be obtained by utilizing an autoregressive model that predicts quantized latents from their causal context, which may be known as a context model.

The term auto-regressive indicates that the output of a process is later used as an input to the process. For example, the context model subnetwork generates one sample of a latent, which is later used as input to obtain the next sample.

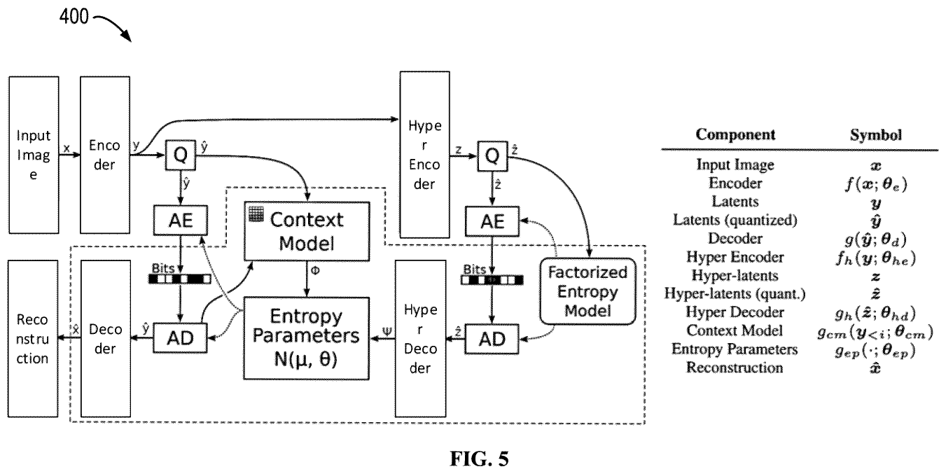

FIG. 5 is a schematic diagram 400 illustrating an example combined model configured to jointly optimize a context model along with a hyperprior and the autoencoder. The combined model jointly optimizes an autoregressive component that estimates the probability distributions of latents from their causal context (Context Model) along with a hyperprior and the underlying autoencoder. Real-valued latent representations are quantized (Q) to create quantized latents (ŷ) and quantized hyper-latents (\hat{z}), which are compressed into a bitstream using an arithmetic encoder (AE) and decompressed by an arithmetic decoder (AD). The dashed region corresponds to the components that are executed by the receiver (e.g, a decoder) to recover an image from a compressed bitstream.

An example system utilizes a joint architecture where both a hyper prior model subnetwork (hyper encoder and hyper decoder) and a context model subnetwork are utilized. The hyper prior and the context model are combined to learn a probabilistic model over quantized latents ŷ, which is then used for entropy coding. As depicted in schematic diagram 400, the outputs of the context subnetwork and hyper decoder subnetwork are combined by the subnetwork called Entropy Parameters, which generates the mean μ and scale (or variance) σ parameters for a Gaussian probability model. The gaussian probability model is then used to encode the samples of the quantized latents into bitstream with the help of the arithmetic encoder (AE) module. In the decoder the gaussian probability model is utilized to obtain the quantized latents ŷ from the bitstream by arithmetic decoder (AD) module.

In an example, the latent samples are modeled as gaussian distribution or gaussian mixture models (not limited to). In the example according to the schematic diagram 400, the context model and hyper prior are jointly used to estimate the probability distribution of the latent samples. Since a gaussian distribution can be defined by a mean and a variance (aka sigma or scale), the joint model is used to estimate the mean and variance (denoted as μ and σ).

### 2.3.5 Gained Variational Autoencoders (G-VAE)

In an example, neural network-based image/video compression methodologies need to train multiple models to adapt to different rates. Gained variational autoencoders (G-VAE) is the variational autoencoder with a pair of gain units, which is designed to achieve continuously variable rate adaptation using a single model. It comprises of a pair of gain units, which are typically inserted to the output of encoder and input of decoder. The output of the encoder is defined as the latent representation y∈R^{c*h*w}, where c, h, w represent the number of channels, the height and width of the latent representation. Each channel of the latent representation is denoted as y₍ᵢ₎∈R^{h*w}, where i=0, 1, . . . , c−1. A pair of gain units include a gain matrix M∈r^{c*n} and an inverse gain matrix, where n is the number of gain vectors. The gain vector can be denoted as mₛ={αₛ₍ₒ₎, αₛ₍₁₎, . . . , α_{s(c-1)}}, αₛ₍ᵢ₎∈R where s denotes the index of the gain vectors in the gain matrix.

The motivation of gain matrix is similar to the quantization table in JPEG by controlling the quantization loss based on the characteristics of different channels. To apply the gain matrix to the latent representation, each channel is multiplied with the corresponding value in a gain vector.

$${\overline{y}}_{s} = y ⊙ {m}_{s}$$

Where ⊙ is channel-wise multiplication, i.e., y̅ₛ₍ᵢ₎=y₍ᵢ₎×αₛ₍ᵢ₎, and αₛ₍ᵢ₎ is the i-th gain value in the gain vector mₛ. The inverse gain matrix used at the decoder side can be denoted as M′∈R^{c*n}, which comprises n inverse gain vectors, i.e., M′={δₛ₍₀₎, δₛ₍₁₎, . . . , δ_{s(c-1)}}, δₛ₍ᵢ₎∈R. The inverse gain process is expressed as

$${( {y}^{′} )}_{s} = \hat{y} ⊙ {m}_{s}^{′}$$

where ŷ is the decoded quantized latent representation and yₛ′ is the inversely gained quantized latent representation, which will be fed into the synthesis network.

To achieve continuous variable rate adjustment, interpolation is used between vectors. Given two pairs of gain vectors {mₜ, mₜ′} and {mᵣ, mᵣ′}, the interpolated gain vector can be obtained via the following equations.

$${m}_{ν} = [ {( {m}_{r} )}^{l} \cdot {( {m}_{t} )}^{1 - l} ]$$

$${m}_{v}^{′} = [ {( {m}_{r}^{′} )}^{l} \cdot {( {m}_{t}^{′} )}^{1 - l} ]$$

where l∈R is an interpolation coefficient, which controls the corresponding bit rate of the generated gain vector pair. Since l is a real number, an arbitrary bit rate between the given two gain vector pairs can be achieved.

### 2.3.6 The Encoding Process Using Joint Auto-Regressive Hyper Prior Model

The design in FIG. 5. corresponds an example combined compression method. In this section and the next, the encoding and decoding processes are described separately.

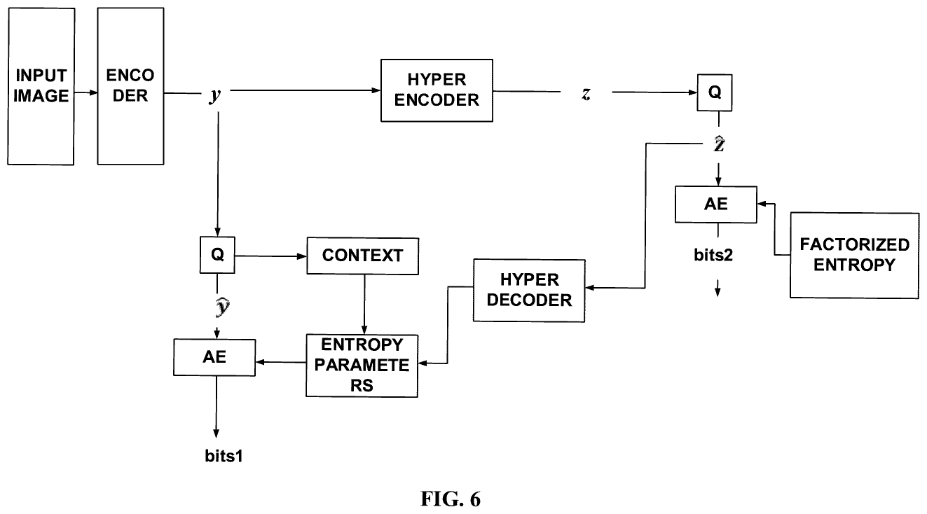

FIG. 6 illustrates an example encoding process. The input image is first processed with an encoder subnetwork. The encoder transforms the input image into a transformed representation called latent, denoted by y. y is then input to a quantizer block, denoted by Q, to obtain the quantized latent (ŷ). ŷ is then converted to a bitstream (bits1) using an arithmetic encoding module (denoted AE). The arithmetic encoding block converts each sample of the ŷ into a bitstream (bits1) one by one, in a sequential order.

The modules hyper encoder, context, hyper decoder, and entropy parameters subnetworks are used to estimate the probability distributions of the samples of the quantized latent ŷ. the latent y is input to hyper encoder, which outputs the hyper latent (denoted by z). The hyper latent is then quantized (\hat{z}) and a second bitstream (bits2) is generated using arithmetic encoding (AE) module. The factorized entropy module generates the probability distribution, that is used to encode the quantized hyper latent into bitstream. The quantized hyper latent includes information about the probability distribution of the quantized latent (ŷ).

The Entropy Parameters subnetwork generates the probability distribution estimations, that are used to encode the quantized latent ŷ. The information that is generated by the Entropy Parameters typically include a mean μ and scale (or variance) σ parameters, that are together used to obtain a gaussian probability distribution. A gaussian distribution of a random variable x is defined as

$$f ( x ) = \frac{1}{σ \sqrt{2 π}} {e}^{- \frac{1}{2} {( \frac{x - μ}{σ} )}^{2}}$$

wherein the parameter μ is the mean or expectation of the distribution (and also its median and mode), while the parameter σ is its standard deviation (or variance, or scale). In order to define a gaussian distribution, the mean and the variance need to be determined. The entropy parameters module are used to estimate the mean and the variance values.

The subnetwork hyper decoder generates part of the information that is used by the entropy parameters subnetwork, the other part of the information is generated by the autoregressive module called context module. The context module generates information about the probability distribution of a sample of the quantized latent, using the samples that are already encoded by the arithmetic encoding (AE) module. The quantized latent ŷ is typically a matrix composed of many samples. The samples can be indicated using indices, such as ŷ[i,j,k] or ŷ[i,j] depending on the dimensions of the matrix ŷ. The samples ŷ[i,j] are encoded by AE one by one, typically using a raster scan order. In a raster scan order the rows of a matrix are processed from top to bottom, wherein the samples in a row are processed from left to right. In such a scenario (wherein the raster scan order is used by the AE to encode the samples into bitstream), the context module generates the information pertaining to a sample ŷ[i,j], using the samples encoded before, in raster scan order. The information generated by the context module and the hyper decoder are combined by the entropy parameters module to generate the probability distributions that are used to encode the quantized latent ŷ into bitstream (bits1).

Finally, the first and the second bitstream are transmitted to the decoder as result of the encoding process. It is noted that the other names can be used for the modules described above.

In the above description, all of the elements in FIG. 6 are collectively called an encoder. The analysis transform that converts the input image into latent representation is also called an encoder (or auto-encoder).

### 2.3.7 The Decoding Process Using Joint Auto-Regressive Hyper Prior Model

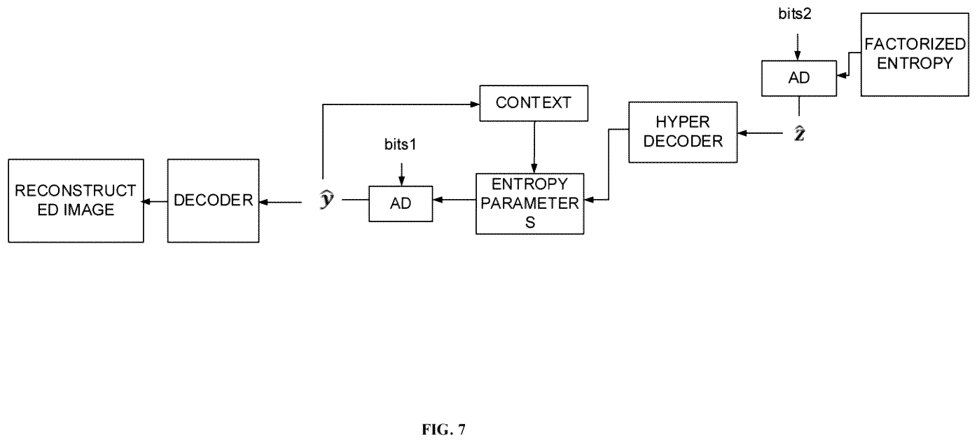

FIG. 7 illustrates an example decoding process. FIG. 7 depicts a decoding process separately.

In the decoding process, the decoder first receives the first bitstream (bits1) and the second bitstream (bits2) that are generated by a corresponding encoder. The bits2 is first decoded by the arithmetic decoding (AD) module by utilizing the probability distributions generated by the factorized entropy subnetwork. The factorized entropy module typically generates the probability distributions using a predetermined template, for example using predetermined mean and variance values in the case of gaussian distribution. The output of the arithmetic decoding process of the bits2 is \hat{z}, which is the quantized hyper latent. The AD process reverts to AE process that was applied in the encoder. The processes of AE and AD are lossless, meaning that the quantized hyper latent 2 that was generated by the encoder can be reconstructed at the decoder without any change.

After obtaining of \hat{z}, it is processed by the hyper decoder, whose output is fed to entropy parameters module. The three subnetworks, context, hyper decoder and entropy parameters that are employed in the decoder are identical to the ones in the encoder. Therefore, the exact same probability distributions can be obtained in the decoder (as in encoder), which is essential for reconstructing the quantized latent ŷ without any loss. As a result, the identical version of the quantized latent ŷ that was obtained in the encoder can be obtained in the decoder.

After the probability distributions (e.g. the mean and variance parameters) are obtained by the entropy parameters subnetwork, the arithmetic decoding module decodes the samples of the quantized latent one by one from the bitstream bits1. From a practical standpoint, autoregressive model (the context model) is inherently serial, and therefore cannot be sped up using techniques such as parallelization. Finally, the fully reconstructed quantized latent ŷ is input to the synthesis transform (denoted as decoder in FIG. 7) module to obtain the reconstructed image.

In the above description, the all of the elements in FIG. 7 are collectively called decoder. The synthesis transform that converts the quantized latent into reconstructed image is also called a decoder (or auto-decoder).

### 2.3.8 Wavelet Based Neural Compression Architecture

FIG. 8 illustrates an example encoder and decoder with wavelet-based transform. The analysis transform (denoted as encoder) in FIG. 6 and the synthesis transform (denoted as decoder) in FIG. 7 might be replaced by a wavelet-based neural network transform. FIG. 8 shows an example of image compression framework with wavelet-based neural network transform. In the figure, first the input image is converted from an RGB color format to a YUV color format. This conversion process is optional, which may be missing in other implementations. If such a conversion is applied to the input image, an inverse conversion (from YUV to RGB) is also applied to the reconstructed image. The core of an encoder with wavelet-based transform comprises a wavelet-based forward transform, a quantization module, and an entropy coding module, which compress the raw images into bitstreams. The core of the decoding process is composed of entropy decoding, de-quantization process and an inverse wavelet-based transform operation. The decoding process convers the bitstream into output image. Similar to the color space conversion, the two postprocessing units shown in FIG. 8 are also optional, which can be removed in some implementations.

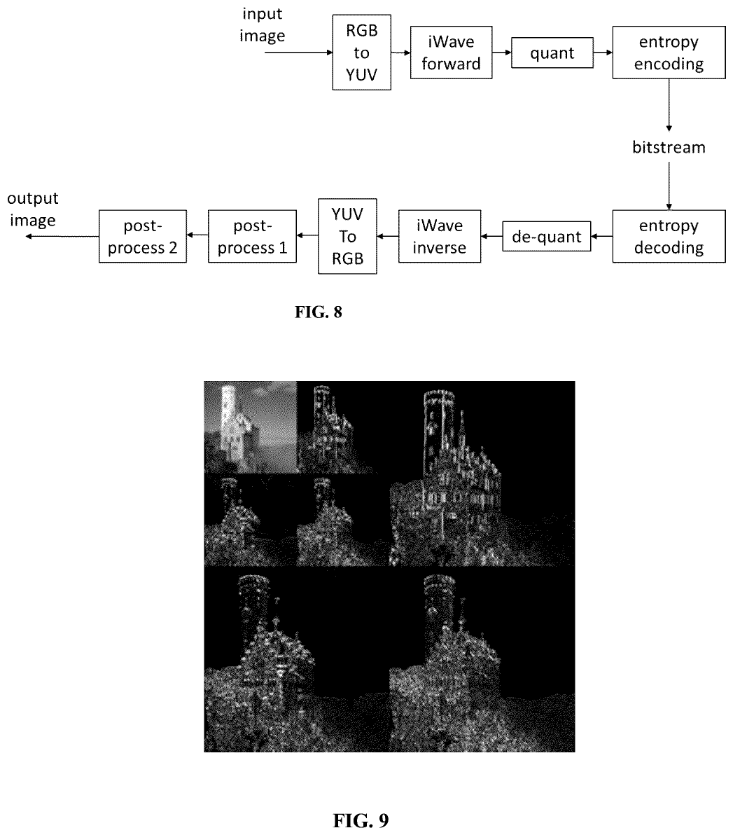

After the wavelet-based transform (iWave forward in FIG. 8), the image is decomposed into high frequency (details) and low frequency (approximation). In each level, there are 4 sub-bands, namely the LL, LH, HH, HL sub-bands. Multiple levels of wavelet-based transforms can be applied. FIG. 9 illustrates an example output of a forward wavelet-based transform. For example, the LL sub-band from the first level decomposition can be further decomposed with another wavelet-based transform, resulting 7 sub-bands in total, as shown in FIG. 9. The input of the transform is an image of a castle. In the example, after the transform an output with 7 distinct regions are obtained. The number of sub-bands is decided by the number of wavelet-based transforms that are applied to the images. The number of sub-bands N_{S} can be expressed as follows.

$${N}_{s} = 3 \times N + 1$$

where N denotes the number (levels) of wavelet-based transforms.

In FIG. 5, one can see that the input image is transformed into 7 regions with 3 small images and 4 even smaller images. The transformation is based on the frequency components, the small image at the bottom right quarter comprises the high frequency components in both horizontal and vertical directions. The smallest image at the top-left corner on the other hand comprises the lowest frequency components both in the vertical and horizontal directions. The small image on the top-right quarter comprises the high frequency components in the horizontal direction and low frequency components in the vertical direction.

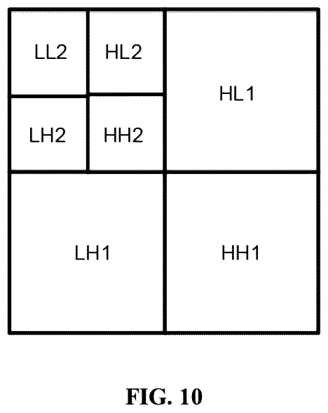

FIG. 10 illustrates an example partitioning of the output of a forward wavelet-based transform. FIG. 10 depicts a possible splitting of the latent representation after the 2D forward transform. The latent representation are the samples (latent samples, or quantized latent samples) that are obtained after the 2D forward transform. The latent samples are divided into 7 sections above, denoted as HH1, LH1, HL1, LL2, HL2, LH2 and HH2. The HH1 describes that the section comprises high frequency components in the vertical direction, high frequency components in the horizontal direction and that the splitting depth is 1. HL2 describes that the section comprises low frequency components in the vertical direction, high frequency components in the horizontal direction and that the splitting depth is 2.

After the latent samples are obtained at the encoder by the forward wavelet transform, they are transmitted to the decoder by using entropy coding. At the decoder, entropy decoding is applied to obtain the latent samples, which are then inverse transformed (by using iWave inverse module in FIG. 8) to obtain the reconstructed image.

### 2.4 Neural Networks for Video Compression

Similar to video coding technologies, neural image compression serves as the foundation of intra compression in neural network-based video compression. Thus, development of neural network-based video compression technology is behind development of neural network-based image compression because neural network-based video compression technology is of greater complexity and hence needs far more effort to solve the corresponding challenges. Compared with image compression, video compression needs efficient methods to remove inter-picture redundancy. Inter-picture prediction is then a major step in these example systems. Motion estimation and compensation is widely adopted in video codecs, but is not generally implemented by trained neural networks.

Neural network-based video compression can be divided into two categories according to the targeted scenarios: random access and the low-latency. In random access case, the system allows decoding to be started from any point of the sequence, typically divides the entire sequence into multiple individual segments, and allows each segment to be decoded independently. In a low-latency case, the system aims to reduce decoding time, and thereby temporally previous frames can be used as reference frames to decode subsequent frames.

### 2.5 Preliminaries

Almost all the natural image and/or video is in digital format. A grayscale digital image can be represented by x∈ [symbol] ^{m×n}, where [symbol] is the set of values of a pixel, m is the image height, and n is the image width. For example, [symbol] ={0, 1, 2, . . . , 255} is an example setting, and in this case | [symbol] |=256=2⁸. Thus, the pixel can be represented by an 8-bit integer. An uncompressed grayscale digital image has 8 bits-per-pixel (bpp), while compressed bits are definitely less.

A color image is typically represented in multiple channels to record the color information. For example, in the RGB color space an image can be denoted by x∈ [symbol] ^{m×n×3} with three separate channels storing Red, Green, and Blue information. Similar to the 8-bit grayscale image, an uncompressed 8-bit RGB image has 24 bpp. Digital images/videos can be represented in different color spaces. The neural network-based video compression schemes are mostly developed in RGB color space while the video codecs typically use a YUV color space to represent the video sequences. In YUV color space, an image is decomposed into three channels, namely luma (Y), blue difference choma (Cb) and red difference chroma (Cr). Y is the luminance component and Cb and Cr are the chroma components. The compression benefit to YUV occur because Cb and Cr are typically down sampled to achieve pre-compression since human vision system is less sensitive to chroma components.

A color video sequence is composed of multiple color images, also called frames, to record scenes at different timestamps. For example, in the RGB color space, a color video can be denoted by X={x₀, x₁, . . . , xₜ, . . . , x_{T-1}} where T is the number of frames in a video sequence and x∈ [symbol] ^{m×n}. If m=1080, n=1920, | [symbol] |=2⁸, and the video has 50 frames-per-second (fps), then the data rate of this uncompressed video is 1920×1080×8×3×50=2,488,320,000 bits-per-second (bps). This results in about 2.32 gigabits per second (Gbps), which uses a lot storage and should be compressed before transmission over the internet.

Usually the lossless methods can achieve a compression ratio of about 1.5 to 3 for natural images, which is clearly below streaming requirements. Therefore, lossy compression is employed to achieve a better compression ratio, but at the cost of incurred distortion. The distortion can be measured by calculating the average squared difference between the original image and the reconstructed image, for example based on MSE. For a grayscale image, MSE can be calculated with the following equation.

$$MSE = \frac{{‖ x - \hat{x} ‖}^{2}}{m \times n} \qquad ( 4 )$$

Accordingly, the quality of the reconstructed image compared with the original image can be measured by peak signal-to-noise ratio (PSNR):

$$PSNR = 10 \times {log}_{10} \frac{{( max ( 𝔻 ) )}^{2}}{MSE} \qquad ( 5 )$$

where max( [symbol] ) is the maximal value in [symbol] , e.g., 255 for 8-bit grayscale images. There are other quality evaluation metrics such as structural similarity (SSIM) and multi-scale SSIM (MS-SSIM).
To compare different lossless compression schemes, the compression ratio given the resulting rate, or vice versa, can be compared. However, to compare different lossy compression methods, the comparison has to take into account both the rate and reconstructed quality. For example, this can be accomplished by calculating the relative rates at several different quality levels and then averaging the rates. The average relative rate is known as Bjontegaard's delta-rate (BD-rate). There are other aspects to evaluate image and/or video coding schemes, including encoding/decoding complexity, scalability, robustness, and so on.

### 3. Technical Problems Solved by Disclosed Technical Solutions

Learning-based wavelet transformation has achieved superior performance in learning-based image compression due to its capability to support both lossy and lossless compression. For further performance improvement, the combination of wavelet-like transformation and nonlinear transformation is a potential topic. However, directly transplanting wavelet-like transformation into the structure of nonlinear transformation still seems to have some problems. It is known that in the learned wavelet forward transformation, input images are transformed into several subbands, which may contain different resolutions. How to properly combine these subbands and feed them into the nonlinear transformation to further remove the correlation between subbands is still a problem.

### 4 Central Examples

To solve the problem and some other problems not mentioned, methods as summarized below are disclosed. Specifically, this disclosure includes a solution, on the encoder and decoder side, to efficiently realize the combination of the wavelet-like transformation and non-linear transformation. More detailed information is disclosed below:

Encoder: A method of converting an input image to bitstream by application of following steps:
Transforming an input image using a wavelet-like transform, wherein the output comprises at least two subbands,
Applying a resizing to at least one of the subbands,
Obtaining the bitstream by applying entropy coding to the said subbands after resizing.

Decoder: A method of converting a bitstream to reconstructed image by application of following steps:
Obtaining at least two subbands by application of entropy decoding on the bitstream,
Applying a resizing to at least one of the subbands,
Transforming the subbands after resizing using a wavelet based transformation.

Details of the at least two subbands:
The subbands might have the approximate sizes of:

$$\frac{W}{2} \times \frac{H}{2} and \frac{W}{4} \times \frac{H}{4} ,$$

$$\frac{W}{2} \times \frac{H}{2} and \frac{W}{4} \times \frac{H}{4} , \frac{W}{8} \times \frac{H}{8}$$

$$\frac{W}{2} \times \frac{H}{2} and \frac{W}{4} \times \frac{H}{4} , \frac{W}{8} \times \frac{H}{8} , \frac{W}{16} \times \frac{H}{16}$$

wherein the H and W relate to the size of the input image or the reconstructed image, and the number of the subbands is dependent on the transformation times of the wavelet. In an example the H might be the height of the input image or the reconstructed image. In another example the W might be the width of the input image or the reconstructed image.

Details of the resizing:
The resizing might be a downsampling or an upsampling operation.
The resizing might be downsampling in the encoder and upsampling in the decoder.
The resizing might be upsampling in the encoder and downsampling in the decoder.
The resizing might be performed by a neural network.
   The neural network used to perform resizing might comprise any of the following:
      A deconvolution layer,
      A convolution layer,
      An attention module,
      A residual block,
      An activation layer,
      A leaky relu layer,
      A relu layer,
      A normalization layer.
The resizing might be performed just on some of the subbands.
The resizing might be performed on all subbands.
The resizing might be performed by according to a target size.
   In one example the target size might be equal to the size of the biggest subband.
   In one example the target size might be equal to the size of the smallest subband.
   In an example target size might be equal to

$$\frac{W}{2} \times \frac{H}{2} , or \frac{W}{4} \times \frac{H}{4} , or \frac{W}{8} \times \frac{H}{8} , or \frac{W}{16} \times \frac{H}{16} .$$

For some subbands, the resizing might be performed in multiple times, through using different resizing operation.
Different resizing operation might be performed on different subbands.
Some subbands might combined in channel dimension before the processing of the resizing.

Obtaining at least two subbands by application of entropy decoding on the bitstream might comprise any of the following:
Obtaining a latent representation by application of entropy decoding to a bitstream,
Dividing the latent into at least two, first division corresponding to the first subband, and second division corresponding to the second subband.
   The division of the latent representation is channel wise, or in the dimension of feature maps.
   The latent representation might be composed of 3 dimensions, a width, a height and a third dimensions that represents number of channels or number of feature maps.
   The division is based on at least one target channel number, wherein the channel number representing the size of the third dimension of the latent.
   In an example the size of the latent might be C, W and H.
      The latent is divided into at least 2 subbands, wherein the size of the first subband is C1, which is smaller than C.
   The latent representation might be divided into predetermined number of channels.

Obtaining the bitstream by applying entropy coding to the said subbands after resizing might comprise any of the following:
Concatenating the subbands into a latent.
   The concatenation might be performed in the channel dimension, wherein if the sizes of the first subband and second subband after resizing are C1, H, W and C2, H, W respectively, the size of the resulting latent is C1+C2, H, W.

### 5 Detailed Examples

Given that N levels of wavelet-based forward transformations are applied to the input image, a group of sub-bands with N spatial sizes are generated. Therefore, N downsampling networks with different downsampling factors are needed to process these sub-bands. These networks are used to unify all the subbands in spatial dimensions. Taking N=4 as an example, the latent samples are divided into 13 sections, denoted as HH1, LH1, HL1, HH2, LH2, HL2, HH3, LH3, HL3, LL4, HL4, LH4 and HH4. These 13 sections might belong to four spatial resolutions as follows.

$$\frac{W}{2} \times \frac{H}{2} : LH 1 , HH 1 , HL 1$$

$$\frac{W}{4} \times \frac{H}{4} : LH 2 , HH 2 , HL 2$$

$$\frac{W}{8} \times \frac{H}{8} : LH 3 , HH 3 , HL 3$$

$$\frac{W}{16} \times \frac{H}{16} : LH 4 , HH 4 , HL 4 , LL 4$$

where W×H is the spatial size of the input of the forward wavelet-based transform.

The techniques describe herein provide a encoder and decoder that is utilized in the combination of learning-based wavelet transformation and non-linear transformation. The designed network is applied to the output subbands after wavelet-like forward transformation. To further reduce the redundancy of subbands, specific non-linear transformation structure is designed in this application.

(1) In summary, the design of the encoder includes the following examples:

For subbands that obtained after the wavelet tranformation, all subbands might be put together though the resizing operation to reduce the redundancy. Let N0, N1, N2, N3, . . . denote the number of output feature map channels of the resized subbands. The resizing operation might be designed in one or more of the following approaches:
1. In one example, to keep all the subbands' detail as much as possible, small subbands are resized by upsampling network to the largest spatial resolution.
   a. In one example, to reduce the complexity of the whole network, the numbers of channels remain unchanged during the resizing operation. The output channel numbers of upsampling denoted as (N0, N1,N2,N3) can be (9, 9, 9, 12).
      i. In one example, to reduce the complexity, the upsampling network consists of convolution layers and activation function.
         1. In one example, sub-pixel convolution layers can be used in upsampling operation.
         a. In one example, generalized divisive normalization (GDN) layer can be added to the upsampling block to enhance is capability of decorrelation.
         b. In one example, the leaky ReLU function is used in upsampling block as activation function.
         c. In one example, the leaky GELU function is used in upsampling block as activation function.
         2. In one example, transposed convolution layers can be used in upsampling operation.
         a. In one example, the upsampling block can add generalized divisive normalization (GDN) layer to enhance is capability of decorrelation.
         b. In one example, the leaky ReLU function is used in upsampling block as activation function.
         c. In one example, the leaky GELU function is used in upsampling block as activation function.
      ii. In one example, to exact subbands' information, the residual blocks can be added to the upsampling network, resulting in a deeper structure.
         1. In one example, residual blocks can be added to all the upsampling blocks.
         a. In one example, sub-pixel convolution layers can be used in upsampling operation.
         i. In one example, the upsampling block can add generalized divisive normalization (GDN) layer to enhance is capability of decorrelation.
         ii. In one example, the leaky ReLU function is used in upsampling block as activation function.
         iii. In one example, the leaky GELU function is used in upsampling block as activation function.
         b. In one example, transposed convolution layers can be used in upsampling operation.
         i. In one example, the upsampling block can add generalized divisive normalization (GDN) layer to enhance is capability of decorrelation.
         ii. In one example, the leaky ReLU function is used in upsampling block as activation function.
         iii. In one example, the leaky GELU function is used in upsampling block as activation function.
         2. In one example, residual block can be implemented and the attention module can be added to the structure in specific layer to enhance the exaction capability of the network.
         a. In one example, sub-pixel convolution layers can be used in upsampling operation.
         i. In one example, the upsampling block can add generalized divisive normalization (GDN) layer to enhance is capability of decorrelation.
         ii. In one example, the leaky ReLU function is used in upsampling block as activation function.
         iii. In one example, the leaky GELU function is used in upsampling block as activation function.
         b. In one example, transposed convolution layers can be used in upsampling operation.
         i. In one example, the upsampling block can add generalized divisive normalization (GDN) layer to enhance is capability of decorrelation.
         ii. In one example, the leaky ReLU function is used in upsampling block as activation function.
         iii. In one example, the leaky GELU function is used in upsampling block as activation function.
   b. In one example, to exact more detail information of the subbands, the numbers of channels increase during the resizing operation. The output channel numbers of upsampling denoted as (N0, N1,N2,N3) can be (16, 16, 16, 32).
      i. In one example, to reduce the complexity, the upsampling network consists of convolution layers and activation function.
         1. In one example, sub-pixel convolution layers can be used in upsampling operation.
         a. In one example, the upsampling block can add generalized divisive normalization (GDN) layer to enhance is capability of decorrelation.
         b. In one example, the leaky ReLU function is used in upsampling block as activation function.
         c. In one example, the leaky GELU function is used in upsampling block as activation function.
         2. In one example, transposed convolution layers can be used in upsampling operation.
         a. In one example, the upsampling block can add generalized divisive normalization (GDN) layer to enhance is capability of decorrelation.
         b. In one example, the leaky ReLU function is used in upsampling block as activation function.
         c. In one example, the leaky GELU function is used in upsampling block as activation function.
      ii. In one example, to exact subbands' information, the residual blocks can be added to the upsampling network, resulting in a deeper structure.
         1. In one example, residual blocks can be added to all the upsampling blocks.
         a. In one example, sub-pixel convolution layers can be used in upsampling operation.
         i. In one example, the upsampling block can add generalized divisive normalization (GDN) layer to enhance is capability of decorrelation.
         ii. In one example, the leaky ReLU function is used in upsampling block as activation function.
         iii. In one example, the leaky GELU function is used in upsampling block as activation function.
         b. In one example, transposed convolution layers can be used in upsampling operation.
         i. In one example, the upsampling block can add generalized divisive normalization (GDN) layer to enhance is capability of decorrelation.
         ii. In one example, the leaky ReLU function is used in upsampling block as activation function.
         iii. In one example, the leaky GELU function is used in upsampling block as activation function.
         2. In one example, residual block can be added to upsampling blocks and the attention module can be added to the structure in specific layer.
         a. In one example, sub-pixel convolution layers can be used in upsampling operation.
         i. In one example, the upsampling block can add generalized divisive normalization (GDN) layer to enhance is capability of decorrelation.
         ii. In one example, the leaky ReLU function is used in upsampling block as activation function.
         iii. In one example, the leaky GELU function is used in upsampling block as activation function.
         b. In one example, transposed convolution layers can be used in upsampling operation.
         i. In one example, the upsampling block can add generalized divisive normalization (GDN) layer to enhance is capability of decorrelation.
         ii. In one example, the leaky ReLU function is used in upsampling block as activation function.
         iii. In one example, the leaky GELU function is used in upsampling block as activation function.
2. In one example, to exact the information of all the subbands as much as possible, large subbands are resized by downsampling network to the smallest spatial resolution.
   a. In one example, to reserve all the subbands' information as much as possible, the numbers of channels gradually increase with the ratio of downsampling. As a result, the output's channel numbers consist of an incremental sequence corresponding to the size of the input subbands:
      i. In one example, the weights of the each downsampling networks are independent. Each downsampling net is designed to process a specific size of subbands. Different structures can be tried depending on the unique feature of the subbands.
         1. In one example, not only the attention block can be added in different order, but the input channel number of the attention block can vary in different downsampling network.
         2. In one example, in every downsampling block, the output channels can vary after each residual block with stride 2.
      ii. In one example, the weights and structure of the downsampling blocks are shared, considering that downsampling blocks have similar function and operation on different subbands. The weight of the block processing small subbands will be reused in the downsampling of larger subbands. The output channel numbers of downsampling denoted as (N0, N1,N2,N3) can be (32, 48, 144, 576).
         1. In one example, the function of the downsampling structure can be enhanced.
         a. In one example, the downsampling block processing the smallest subbands can add generalized divisive normalization (GDN) layer to enhance is capability of decorrelation.
         b. In one example, different numbers of GDN and convolution layers can be added in different downsampling block to make sure that each subbands go through GDN layers of the same times.
         2. Alternatively, the structure of merging-and-decorrelation network after the downsampling operation can be enhanced.
         a. In one example, more attention blocks can be added in this part, resulting in deeper structure.
         b. In one example, GDN layers can be added between residual block to enhance the decorrelation ability.
   b. In one example, since lager subbands carry more high-frequency information which can be partly give up in end-to-end image compression, the output channel number of the first and the second largest subbands can be reduced.
      i. In one example, the weights of the downsampling blocks are independent. Each downsampling net is designed aimed at specific size of subbands. Different structures can be tried depending on the unique feature of the subbands.
         1. In one example, not only the attention block can be added in different order, but the input channel number of the attention block can vary in different downsampling network.
         2. In one example, in every downsampling block, the output channels can vary after each residual block with stride 2.
      ii. In one example, the weights and structure of the downsampling blocks are shared, considering that downsamplings have similar function and operation on different subbands. The weight of the block processing small subbands will be reused in the downsampling of larger subbands.
         1. In one example, different operations can be done on the first and second largest subband.
         a. In one example, keep the structure of the downsampling block on second largest subbands and reduce the output's channel number of the biggest subbands. The output channel numbers of downsampling denoted as (N0,N1,N2,N3) can be (36,36,192,192).
         b. In one example, More radical reduction on output channels can be applied to both downsampling structure. The output channel numbers of downsampling denoted as (N0,N1,N2,N3) can be (36,36,144,192).
         2. In one example, the structure of merging-and-decorrelation network should be enhanced since the downsampling blocks are simplified to some extent.
         a. In one example, more attention blocks and more residual blocks can be added in this part, resulting in deeper structure.
         b. In one example, more generalized divisive normalization layers can be added between residual block to enhance the decorrelation ability.
   c. In one example, given that smaller subbands carry more low-frequency information which is more significant to image compression compared with the high-frequency information carried by the larger subbands. Thus, smaller subbands' output channel number can be increased while the output channel number of the lager subbands can be reduced.
      i. In one example, the weights of the downsampling blocks are independent. Each downsampling net is designed aimed at specific size of subbands. Different structures can be tried depending on the unique feature of the subbands.
         1. In one example, not only the attention block can be added in different order, but the input channel number of the attention block can vary in different downsampling network.
         2. In one example, in every downsampling block, the output channels can vary after each residual block with stride 2.
      ii. In one example, the weights and structure of the downsampling blocks are shared, considering that downsamplings have similar function and operation on different subbands. The weight of the block processing small subbands may be fully or partially reused in the downsampling of larger subbands.
         1. In one example, different approaches can be adopted on different downsampling block.
         a. In one example, both the increase and the decrease in output channel numbers are mild. The different blocks' output channels still consist an incremental sequence corresponding to the size of the input subbands overall.
         b. In one example, More radical change on all the downsampling structure. All blocks' out put channel numbers are same. The output channel numbers of downsampling denoted as (N0,N1,N2,N3) can be (192,192,192,192).
         2. In one example, the structure of merging-and-decorrelation network can be enhanced since the downsampling blocks may be simplified.
   d. Another approach is to process the subbands by the descending order of their size: the largest subband, after first go through an embedding net and then downsampled, will be combined with the embedded second-largest one and fed to the next downsampling block. Since all the subbands have been resized to the same level, the ultimate net remove the correlation in channel dimension and modify the channel number. The method can be designed in one or more of the following approaches.
      i. In one example, each downsampling block's output channel numbers are fixed. For example, the output channel numbers of downsampling denoted as (N0,N1,N2,N3) can be (192,192,192,192).
      ii. In one example, the downsampling block's output channel numbers gradually increase as more embeded subbands are spliced to the output. For example, the output channel numbers of downsampling denoted as (N0,N1,N2,N3) can be (192,224,256,288).
(2) As the inverse operation of the encoder, example embodiments of the decoder includes the following solutions. For latent feature that obtained after the entropy coding module, all subbands might be reconstructed though the resizing operation to restore the information. The latent feature will firstly be processed by non-linear up-transformation and split to different subbands in channel dimension and then go through corresponding upsampling blocks. Let N0, N1, N2, N3, . . . denote the number of channels of the input feature map. The resizing operation might be designed in one or more of the following approaches.
1. Corresponding to the upsampling blocks used in encoder, the downsampling network can be used in resizing operation in decoder.
   a. In one example, to reduce the complexity of the whole network, the numbers of channels remain unchanged during the resizing operation. The output channel numbers of downsampling block denoted as (N0, N1,N2,N3) can be (9, 9, 9, 12).
      i. In one example, to reduce the complexity, the downsampling network consists of convolution layers and activation function.
         1. In one example, the downsampling block can add inverse generalized divisive normalization (iGDN) layer.
         2. In one example, the leaky ReLU function is used in downsampling block as activation function.
         3. In one example, the leaky GELU function is used in downsampling block as activation function.
      ii. In one example, to exact subbands' information, the residual blocks can be added to the downsampling network, resulting in a deeper structure.
         1. In one example, residual blocks can be added to all the downsampling blocks.
         a. In one example, the downsampling block can add inverse generalized divisive normalization (iGDN) layer.
         b. In one example, the leaky ReLU function is used in downsampling block as activation function.
         c. In one example, the leaky GELU function is used in donwsampling block as activation function.
         2. In one example, residual block can be added to specific downsampling blocks.
         a. In one example, the downsampling block can add inverse generalized divisive normalization (iGDN) layer.
         b. In one example, the leaky ReLU function is used in downsampling block as activation function.
         c. In one example, the leaky GELU function is used in downsampling block as activation function.
   b. In one example, the numbers of channels unchanged during the resizing operation. The output channel numbers of different downsampling block can be different.
      i. In one example, to reduce the complexity, the downsampling network consists of convolution layers and activation function.
         1. In one example, the downsampling block can add inverse generalized divisive normalization (iGDN) layer.
         2. In one example, the leaky ReLU function is used in downsampling block as activation function.
         3. In one example, the leaky GELU function is used in downsampling block as activation function.
      ii. In one example, to exact subbands' information, the residual blocks can be added to the downsampling network, resulting in a deeper structure.
         1. In one example, residual blocks can be added to all the downsampling blocks.
         a. In one example, the downsampling block can add inverse generalized divisive normalization (iGDN) layer.
         b. In one example, the leaky ReLU function is used in downsampling block as activation function.
         c. In one example, the leaky GELU function is used in donwsampling block as activation function.
         2. In one example, residual block can be added to specific downsampling blocks.
         a. In one example, the downsampling block can add inverse generalized divisive normalization (iGDN) layer.
         b. In one example, the leaky ReLU function is used in downsampling block as activation function.
         c. In one example, the leaky GELU function is used in downsampling block as activation function.
2. Corresponding to the downsampling blocks used in encoder, the upsampling network can be used in resizing operation in decoder.
   a. In one example, to restore all the subbands' information as much as possible, the number of channels gradually increase with the ratio of upsampling. As a result, the output's channel numbers consist of an incremental sequence corresponding to the size of the input latent samples.
      i. In one example, the weights of the each upsampling networks are independent. Each upsampling net is designed to process a latent feature with specific channel number. Different structures can be tried depending on the unique feature of the input.
         1. In one example, not only the attention block can be added in different order, but the input channel number of the attention block can vary in different upsampling network.
         2. In one example, in every upsampling block, the output channels can vary after each residual block with stride 2.
      ii. In one example, the weights and structure of the upsampling blocks are shared, considering that upsampling blocks have similar function and operation on different inputs. The weight of the block processing subbands with small channel number will be reused in the upsampling of larger ones. The input channel numbers of upsampling, denoted as (N0, N1,N2,N3), can be (32, 48, 144, 576).
         1. In one example, the function of the upsampling structure can be enhanced.
         a. In one example, the upsampling block processing the smallest inputs can add inverse generalized divisive normalization (iGDN) layer to enhance is capability of decorrelation.
         b. In one example, different numbers of iGDN and convolution layers can be added in different upsampling block to make sure that each subbands go through iGDN layers of the same times.
         2. Alternatively, the structure of up-transformation network before the upsampling operation can be enhanced.
         a. In one example, more attention blocks can be added in this part, resulting in deeper structure.
         b. In one example, iGDN layers can be added between residual block to enhance the decorrelation ability.
   b. In one example, since lager subbands carry more high-frequency information which can be partly give up in end-to-end image compression, the input channel number corresponding to the first and the second largest subbands can be reduced.
      i. In one example, the weights of the upsampling blocks are independent. Each upsampling net is designed aimed at specific size of subbands. Different structures can be tried depending on the unique feature of the subbands.
         1. In one example, not only the attention block can be added in different order, but the input channel number of the attention block can vary in different upsampling network.
         2. In one example, in every upsampling block, the output channels can vary after each residual block with stride 2.
      ii. In one example, the weights and structure of the upsampling blocks are shared, considering that upsamplings have similar function and operation on different subbands. The weight of the block processing subbands with smaller channel number will be reused in the upsampling of larger ones.
         1. In one example, different operations can be done on the first and second largest subband.
         a. In one example, keep the structure of the upsampling block on second largest subbands and reduce the output's channel number of the biggest subbands. The input channel numbers of upsampling denoted as (N0,N1,N2,N3) can be (36,36,192,192).
         b. In one example, More radical reduction on input channels can be applied to both upsampling structure. The input channel numbers of upsampling denoted as (N0,N1,N2,N3) can be (36,36,144,192).
         2. In one example, the structure of up-transformation network should be enhanced since the upsampling blocks are simplified.
         a. In one example, more attention blocks and more residual blocks can be added in this part, resulting in deeper structure.
         b. In one example, more inverse generalized divisive normalization layers can be added between residual block to enhance the decorrelation ability.
   c. In one example, given that smaller subbands carry more low-frequency information which is more significant to image compression compared with the high-frequency information carried by the larger subbands. Thus, input channel number corresponding to smaller subbands can be increased while the input channel number of the lager subbands can be reduced.
      i. In one example, the weights of the upsampling blocks are independent. Each upsampling net is designed aimed at specific size of subbands. Different structures can be tried depending on the unique feature of the subbands.
         1. In one example, not only the attention block can be added in different order, but the input channel number of the attention block can vary in different upsampling network.
         2. In one example, in each upsampling block, the output channels can vary after each residual block with stride 2.
      ii. In one example, the weights and structure of the upsampling blocks are shared, considering that upsamplings have similar function and operation on different subbands. The weight of the upsampling network that used in the processing of the small subbands may be fully or partially reused in the upsampling network of larger subbands.
         1. In one example, different approaches can be adopted on different upsampling block.
         a. In one example, both the increase and the decrease in input channel numbers are mild. The different blocks' output channels still consist an incremental sequence corresponding to the size of the input subbands overall.
         b. In one example, More radical change on all the upsampling structure. Input channel numbers of all upsampling blocks are same. The input channel numbers of upsampling that denoted as (N0,N1,N2,N3) can be (192,192,192,192).
         2. In one example, the structure of up-transformation network can be enhanced, and the upsampling blocks may be simplified.
   d. Another approach is to process the subbands by the descending order of their size: the latent feature will first go through an upsampling net and then be split to two parts. The bigger parts will be fed to next upsampling module while small one will become the subband after the resize operation. Same operation will be repeated till all the subbands are reconstructed The method can be designed in one or more of the following approaches.
      i. In one example, each upsampling block's output channel numbers are fixed. For example, the input channel numbers of upsampling denoted as (N3,N2,N1,N0) can be (192,192,192,192).
      ii. iv. In one example, the upsampling block's output channel numbers gradually decrease as more embeded subbands are split from the input. For example, the input channel numbers of upsampling denoted as (N3,N2,N1,N0) can be (288,256,224,192).

### 6. Embodiments

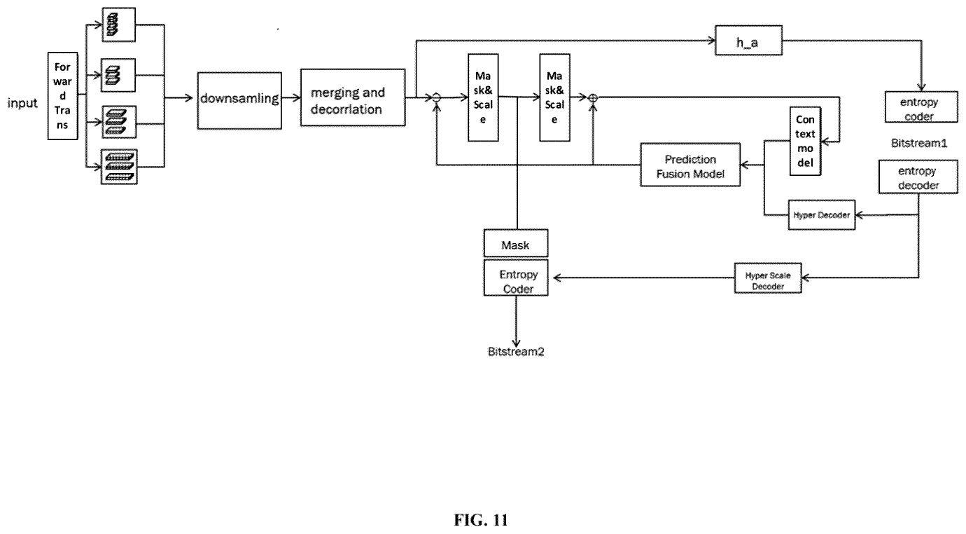

FIG. 11 illustrates an example encoding process.

FIG. 11 illustrates an example structure of the encoding process. Input images are processed by the wavelet-like network and transformed to 13 subbands of four different spatial resolutions. Each subbands are reshaped by their own downsampling blocks to get the same target size. All the subbands might go through the merging and decorrelation network to reduce the channel-wise redundancy. The processed latent features are encoded by an entropy encoding module to obtain the bitstream. It is noted that the 13 subbands described above are provided just as an example. The disclosure applies to any wavelet-based transformation, wherein at least two subbands with different sizes are generated as output. The “merging and decorrelation” module is also given just as an example, the disclosure applies also to cases to any other neural network that might be applied after the downsampling step. The merging and decorrelation module (or any other neural network that might be applied after downsampling and before entropy coding) is optional.

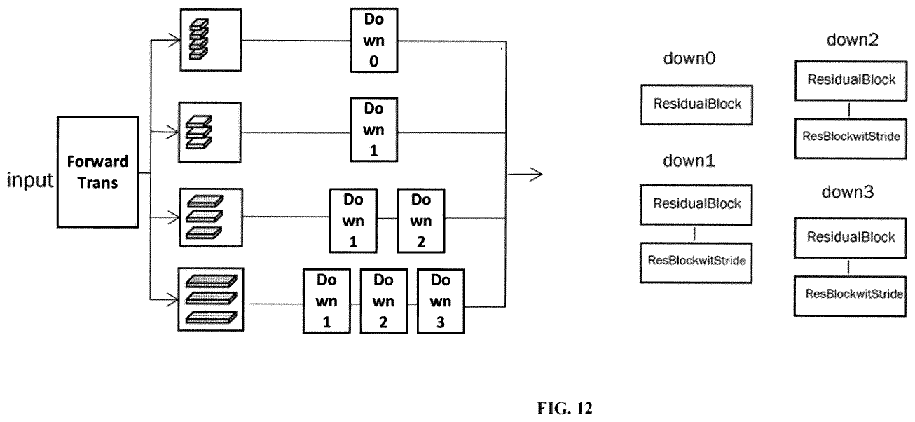

FIG. 12 illustrates an example downsampling network architecture used to unify the spatial sizes of the sub-bands. FIG. 12 depicts the examples of the downsampling blocks. According to the disclosure, input feature may be processed with 4 individual branch to obtain 4 group information depending on their spatial resolution. The downsampling block's weights are denoted as Down1, Down2, Down3, Down0 in the FIG. 12. on the right hand side of the figure, example downsampling networks are depicted, which include:
A downsampling block with a single residual block,
A downsampling block with a single residual block followed by a residual block with stride.

It is noted that 4 downsampling blocks depicted in the above example is for illustration purposes only. The disclosure applies when the number of subbands is greater than 1, and when there is at least one downsampling block.

The number of output channels (or feature maps) of the downsampling blocks might be different. For example, if the width or height of a first subband is larger than a the width or height of a second subband, the number of output channels after downsampling the first subband might be larger than the second subband.

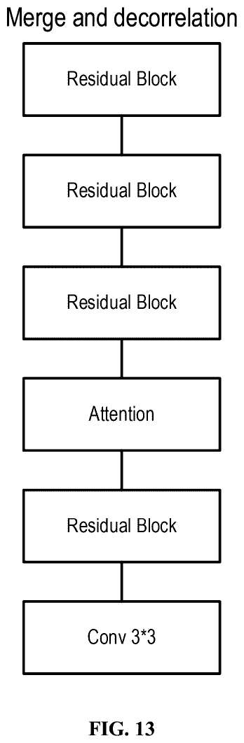

FIG. 13 illustrates an example of non-linear merging and decorrelation. FIG. 13 depicts the details of the merging and decorrelation block. After all the subbands are processed to the same spatial resolution, they might be fed to the merge and decorrelation block comprising any of Residual Block, attention block or convolution layer. As FIG. 13 depicts, the up-transformation block includes:
A single residual block,
A attention block,
A convolution layer with kernel size 3 and stride 1.

It is noted that merging and decorrelation depicted in the above example is for illustration purposes only. The disclosure applies when the number of subbands is greater than 1, and when there is at least one downsampling block. Other non-linear transformation block can also add in this part.

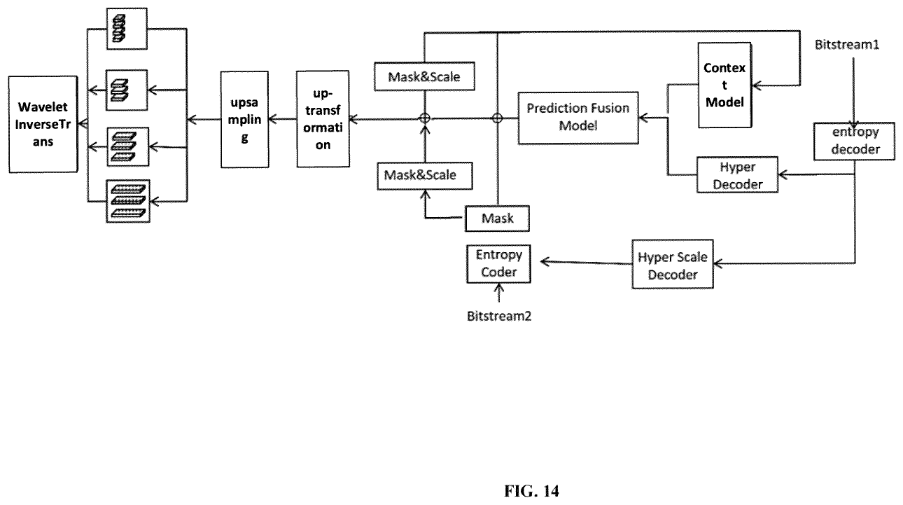

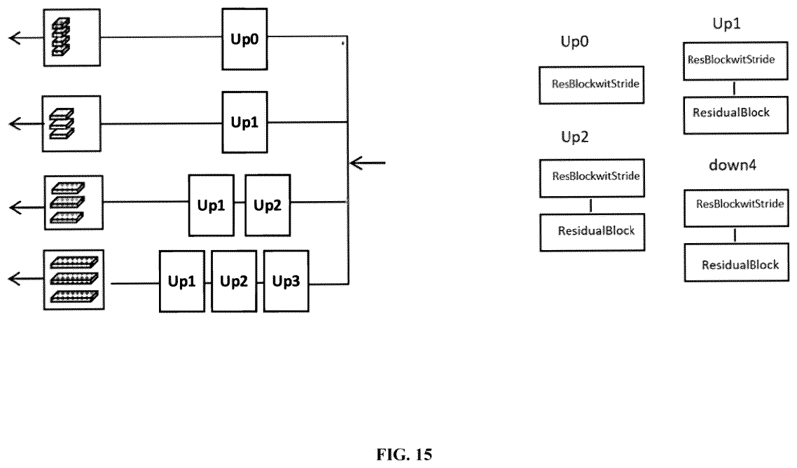

FIG. 14 illustrates an example decoding process. FIG. 14 illustrates an example structure of the decoding process. In the decoding process firstly the bitstream is decoded by entropy decoding module and the quantized latent representation is obtained by obtaining it's samples. The latent representation will be processed by up-transformation to exact feature and increase channel number. Afterwards, the latent feature might be split to 13 subbands of for different channel numbers. Each subbands are reshaped by their own upsampling block to get different spatial resolutions. Then the subbands of different size will be fed to the four-step inverse transformation in wavelet-like network. It is noted that the 13 subbands described above are provided just as an example. The disclosure applies to any wavelet based transformation, wherein at least two subbands with different sizes are generated as output. The “up-transformation” module is also given just as an example, the disclosure applies also to cases to any other neural network that might be applied after the upsampling step. The up-transformation module (or any other neural network that might be applied before upsampling and after entropy coding) is optional.

FIG. 15 illustrates an example upsampling network architecture. FIG. 15 depicts the examples of the upsampling blocks. According to the disclosure, input feature may be processed with 4 individual branch to obtain 4 group information depending on their channel number. The upsampling block's weights are denoted as Down1, Down2, Down3, Down0 in FIG. 15. on the right hand side of the figure, example upsampling networks are depicted, which include:
A upsampling block with a single residual block,
A upsampling block with a single residual block followed by a residual block with stride.

It is noted that 4 upsampling blocks depicted in the above example is for illustration purposes only. The disclosure applies when the number of subbands is greater than 1, and when there is at least one upsampling block.

The number of input channels (or feature maps) of the upsampling blocks might be different. For example, if the width or height of a first subband is larger than a width or height of a second subband, the number of input channels after upsampling the first subband might be larger than the second subband.

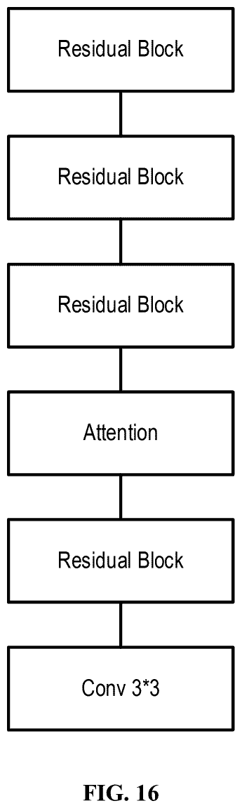

FIG. 16 illustrates an example of non-linear merging and decorrelation. FIG. 16 depicts the details of the up-transformation block. After the quantized latent samples are obtained, they might be fed to the up-transformation block comprising any of Residual Block, attention block or convolution layer to adjust the channel numbers and exact information. As FIG. 16 depicts, the up-transformation block includes:
A single residual block,
An attention block,
A convolution layer with kernel size 3 and stride 1.

It is noted that up-transformation blocks depicted in the above example is for illustration purposes only. The disclosure applies when the total channel number of upsampling's input is greater than the latent feature's, and when there is at least one upsampling block. Other non-linear transformation block can also add to this part for feature exaction.

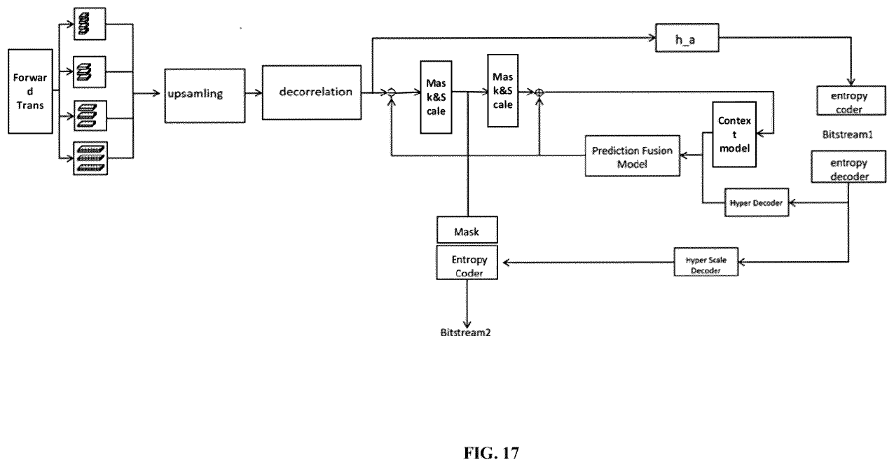

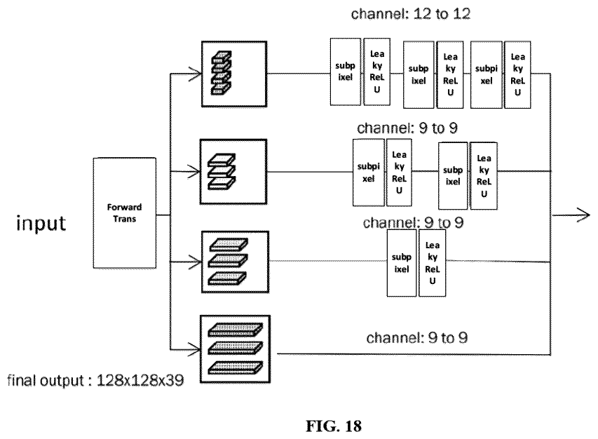

FIG. 17 illustrates an example structure of the encoding process implementing upsampling methods. Input images are processed by the wavelet-like network and transformed to 13 subbands of four different spatial resolutions. Each subbands are reshaped by upsampling blocks to get the same target size. All the subbands might go through the merging and decorrelation network to reduce the channel-wise redundancy. The processed latent features are encoded by an entropy encoding module to obtain the bitstream. It is noted that the 13 subbands described above are provided just as an example. The present disclosure applies to any wavelet based transformation, wherein at least two subbands with different sizes are generated as output. The “merging and decorrelation” module is also given just as an example, the present disclosure applies also to cases to any other neural network that might be applied after the downsampling step. The merging and decorrelation module (or any other neural network that might be applied after downsampling and before entropy coding) is optional.

FIG. 18 illustrates an example of the upsampling network architectures used to unifying the spatial sizes of the sub-bands.

FIG. 18 depicts the examples of the upsampling blocks. According to the present disclosure, input feature may be processed with several individual branch to obtain 4 group information depending on their spatial resolution. The example of upsampling block include:
A upsampling block with a subpixel layer followed by leaky ReLU layer.

It is noted that upsampling blocks depicted in the above example is for illustration purposes only. The present disclosure applies when the number of subbands is greater than 1, and when there is at least one upsampling block.

The number of output channels (or feature maps) of the downsampling blocks might be different. For example, if the width or height of a first subband is larger than a the width or height of a second subband, the number of output channels after upsampling the first subband might be larger than the second subband.

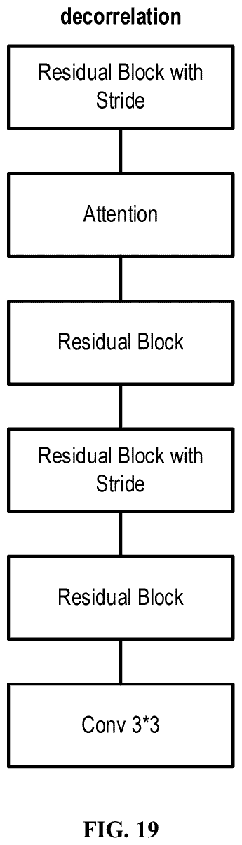

FIG. 19 illustrates a non-linear merging and decorrelation.

FIG. 19 depicts the details of the decorrelation block. After all the subbands are processed to the same spatial resolution, they might be fed to the merge and decorrelation block consisting any of of Residual Block, attention block or convolution layer. As FIG. 19 depicts, the up-transformation block includes:
A single residual block,
An attention block,
A convolution layer with kernel size 3 and stride 1,
A downsampling block with a single residual block followed by a residual block with stride.

It is noted that merging and decorrelation depicted in the above example is for illustration purposes only. The present disclosure applies when the number of subbands is greater than 1, and when there is at least one downsampling block. Other non-linear transformation block can also add in this part.

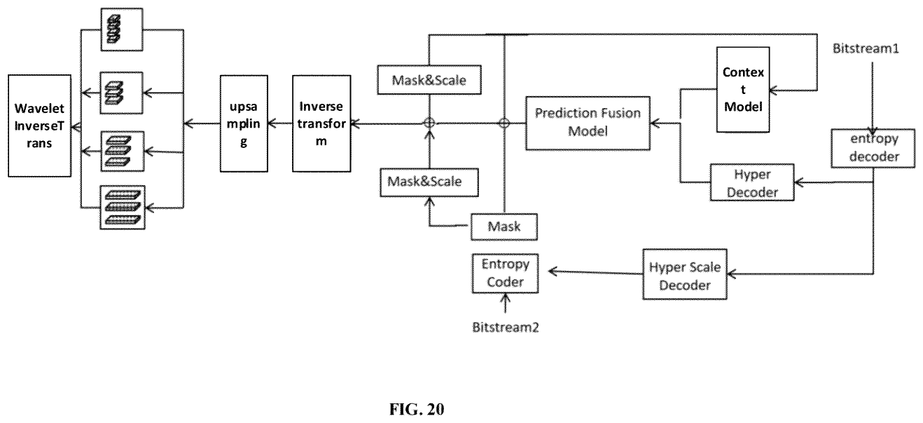

FIG. 20 illustrates an example of the decoding process.

FIG. 20 illustrates an example structure of the decoding process. In the decoding process firstly the bitstream is decoded by entropy decoding module and the quantized latent representation is obtained by obtaining it's samples. The latent representation will be processed by inverse transformation to exact feature and reduce channel number. Afterwards, the latent feature might be split to 13 subbands of for different channel numbers. Each subbands are reshaped by their own downsampling block to get different spatial resolutions. Then the subbands of different size will be fed to the four-step inverse transformation in wavelet-like network. It is noted that the 13 subbands described above are provided just as an example. The present disclosure applies to any wavelet based transformation, wherein at least two subbands with different sizes are generated as output. The “up-transformation” module is also given just as an example, the present disclosure applies also to cases to any other neural network that might be applied after the upsampling step. The up-transformation module (or any other neural network that might be applied before upsampling and after entropy coding) is optional.

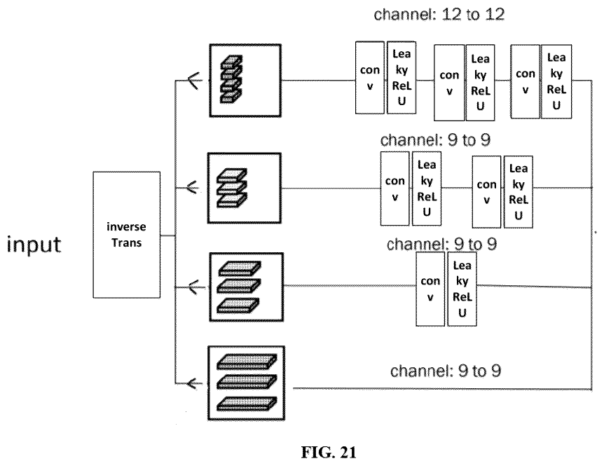

FIG. 21 illustrates an example of the downsampling network architectures.

FIG. 21 depicts the examples of the upsampling blocks. According to the present disclosure, input feature may be processed with 4 individual branch to obtain 4 group information depending on their channel number. The downsampling block's weights are denoted as shown in the FIG. 21, including:
A downsampling block with a single convolution layer and leaky ReLU.

It is noted that downsampling blocks depicted in the above example is for illustration purposes only. The present disclosure applies when the number of subbands is greater than 1, and when there is at least one downsampling block.

The number of input channels (or feature maps) of the downsampling blocks might be different. For example, if the width or height of a first subband is larger than a the width or height of a second subband, the number of input channels after upsampling the first subband might be larger than the second subband.

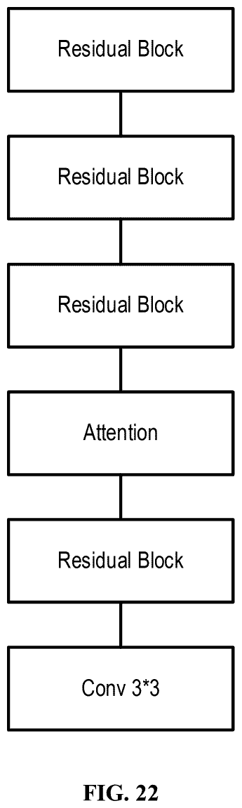

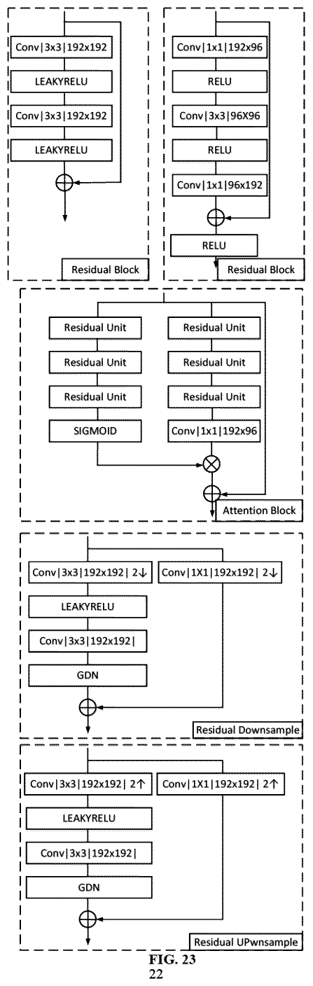

FIG. 22 illustrates non-linear inverse transformation.

FIG. 22 depicts the details of the inverse transformation block. After the quantized latent samples are obtained, they might be fed to the transformation block consisting any of of Residual Block, attention block or convolution layer to adjust the channel numbers and exact information. As FIG. 22 depicts, the up-transformation block includes:
A single residual block,
A attention block,
A convolution layer with kernel size 3 and stride 1.

It is noted that inverse transformation blocks depicted in the above example is for illustration purposes only. The present disclosure applies when the total channel number of upsampling's input is greater than the latent feature's, and when there is at least one upsampling block. Other non-linear transformation block can also add to this part for feature exaction.

FIG. 23 illustrates an example of sub-networks, which may be utilized in FIG. 12 to FIG. 22.

FIG. 23 depicts the details of an example attention block, residual downsample block, residual unit, residual block and residual upsample block. Residual block is composed of convolution layers, leaky ReLU and a residual connection. Based on residual block, residual unit add another ReLU layer to get the final output. Attention block might comprise two branches and a residual connection. Branches have residual unit and convolution layer. Residual downsample block might comprise convolution layer with stride2, leaky ReLU, convolution layer with stride 1, and generalized divisive normalization (GDN). It might also comprise a 2-stride convolution layer in its residual connection. Residual upsample block might comprise convolution layer with stride2, leaky ReLU, convolution layer with stride 1, and inverse generalized divisive normalization (iGDN). It might also comprise a 2-stride convolution layer in its residual connection.

More details of the embodiments of the present disclosure will be described below which are related to neural network-based visual data coding. As used herein, the term “visual data” may refer to a video, an image, a picture in a video, or any other visual data suitable to be coded. As used herein, the terms “(first) module for prediction fusion” and “prediction fusion net” may be used interchangeably. The terms “second module for hyper scale decoder” and “a hyper scale decoder” may be used interchangeably.

As discussed above, in the existing design, an autoregressive loop in a neural network (NN)-based model comprises a context model net, prediction fusion net, and a hyper scale decoder. The prediction fusion net and the hyper scale decoder may consume a large amount of time during the autoregressive process. This results in an increase of time need for the whole coding process, and thus the coding efficiency deteriorates.

To solve the above problems and some other problems not mentioned, visual data processing solutions as described below are disclosed. Embodiments of the present disclosure should be considered as examples to explain the general concepts and should not be interpreted in a narrow way. Furthermore, these embodiments can be applied individually or combined in any manner.

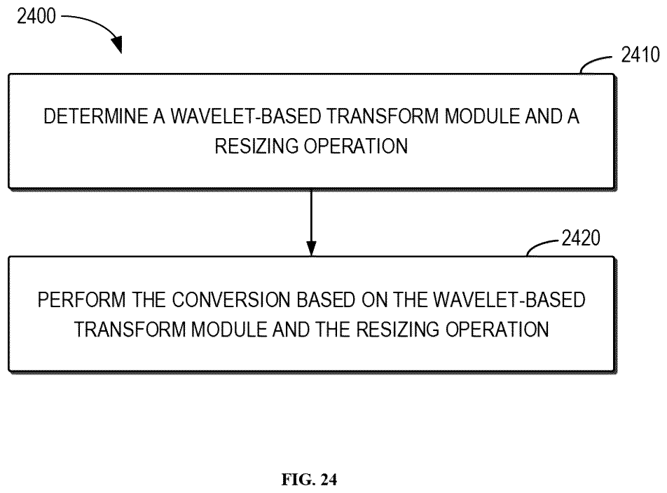

FIG. 24 illustrates a flowchart of a method 2400 for visual data processing in accordance with some embodiments of the present disclosure. The method 2400 is implemented during a conversion between visual data and a bitstream of the visual data.

At block 2410, for a conversion between a visual data and a bitstream of the visual data, a wavelet-based transform module and a resizing operation are determined.

At block 2420, the conversion between the visual data and the bitstream of the visual data is performed based on the wavelet-based transform module and the resizing operation. In some embodiments, the conversion may include encoding the visual data into the bitstream. Additionally, or alternatively, the conversion may include decoding the visual data from the bitstream. In this way, it can improve performances and remove the correlations between subbands. Further, it can efficiently realize the combination of the wavelet-based transformation and non-linear transformation.

In some embodiments, performing the conversion may include obtaining a plurality subbands of the visual data transforming the visual data using the wavelet-based transform module; applying the resizing operation to at least one subband of the plurality of subbands; and obtaining the bitstream by applying an entropy coding to the plurality of subbands after the resizing operation. In some other embodiments, performing the conversion may include obtaining a plurality subbands of the visual data by applying an entropy decoding to the bitstream; applying the resizing operation to at least one subband of the plurality of subbands; and applying a transforming operation on the plurality of subbands after the resizing operation using the wavelet-based transform module.

In some embodiments, sizes of the plurality of subbands comprise one of:

$$\frac{W}{4} \times \frac{H}{4} , and \frac{W}{8} \times \frac{H}{8} , or \frac{W}{2} \times \frac{H}{2} \frac{W}{4} \times \frac{H}{4} , \frac{W}{8} \times \frac{H}{8} and , \frac{W}{16} \times \frac{H}{16} .$$

For example, H and W relate to a size of the visual data or a reconstructed visual data, and the number of subbands is dependent on transformation times of the wavelet. For example, H is a height of the visual data or the reconstructed visual data. Alternatively, or in addition, W is a width of the input visual data or the reconstructed visual data.

In some embodiments, the resizing operation comprises a downsampling or an upsampling operation. In other some embodiments, the resizing operation comprises a downsampling operation in an encoder and an upsampling operation in a decoder. In some further embodiments, the resizing operation comprises an upsampling operation in an encoder and a downsampling operation in a decoder.

In some embodiments, the resizing operation is performed by a neural network. For example, the neural network used to perform the resizing operation comprises at least one of: a deconvolution layer, a convolution layer, an attention module, a residual block, an activation layer, a leaky rectified linear unit (ReLU) layer, a ReLU layer, or a normalization layer.

In some embodiments, the resizing operation is performed on a subset of the plurality of subbands. In some other embodiments, the resizing operation is performed on all subbands of the plurality of subbands.

In some embodiments, the resizing operation is performed according to a target size. For example, the target size is equal to a size of a biggest subband. As another example, the target size is equal to a size of a smallest subband. In some embodiments, the target size is equal to

$$\frac{W}{2} \times \frac{H}{2} , or \frac{W}{4} \times \frac{H}{4} , or \frac{W}{8} \times \frac{H}{8} , or \frac{W}{16} \times \frac{H}{16} ,$$

where H and W relate to a size of the visual data or a reconstructed visual data.

In some embodiments, the resizing is performed on a subset of the plurality of subbands for a plurality of times by using different resizing operation. In some embodiments, different resizing operations are performed on different subbands. In some embodiments, a subset of subbands of the plurality of subbands are combined in channel dimension before a processing of the resizing.

In some embodiments, obtaining the plurality of subbands by applying the entropy decoding on the bitstream comprises at least one of: obtaining a latent representation by applying the entropy decoding to the bitstream; or dividing the latent representation into at least two divisions. In some embodiments, a first division is corresponding to a first subband of the plurality of subbands, and a second division is corresponding to a second subband of the plurality of subbands. For example, the division of the latent representation is channel wise, or in dimension of feature maps.

In some embodiments, the latent representation comprises 3 dimensions including a width, a height and a third dimensions that represents number of channels or number of feature maps. For example, the division is based on at least one target channel number, wherein the channel number represents a size of the third dimension of the latent representation.

In some embodiments, a size of the latent representation is C, W and H, where W represents a width, H represents a height, and C represents number of channels or number of feature maps. In some embodiments, the latent representation is divided into at least 2 subbands, where a size of the first subband is C1, which is smaller than C.

In some embodiments, the latent representation is divided into predetermined number of channels. In some embodiments, obtaining the bitstream by applying the entropy coding to the plurality of subbands after the resizing operation comprises concatenating the plurality of subbands into a latent representation. For example, the concatenation is performed in channel dimension, wherein if sizes of a first subband and a subband after resizing are C1, H, W and C2, H, W respectively, a size of the latent representation is C1+C2, H, W.

In some embodiments, if N levels of wavelet-like forward transformations are applied to the visual data, a group of subbands with N spatial sizes are generated, N downsampling modules with different downsampling factors are used to process the group of subbands, and the N downsampling modules are used to unify all subbands in spatial dimensions, where N is an integer number.

In some embodiments, for subbands that obtained after the wavelet tranformation, all subbands are put together though the resizing operation. In some embodiments, subbands with smaller sizes than other subbands in the plurality of subbands are resized by upsampling module to a largest spatial resolution. In this way, it can keep all subbands' detail as much as possible.

In some embodiments, the numbers of channels remain unchanged during the resizing operation, and the number of output feature map channels of the resized subbands are (9, 9, 9, 12). In this way, it can reduce the complexity of the whole network.

In some embodiments, the upsampling module comprises convolution layers and an activation function. In this way, it can reduce the complexity of the whole network.

In some embodiments, sub-pixel convolution layers are used in upsampling operation. In some other embodiments, transposed convolution layers are used in the upsampling operation.

In some embodiments, a generalized divisive normalization (GDN) layer is added to the upsampling module. In some other embodiments, a leaky ReLU function is used in the upsampling module as the activation function. In some further embodiments, a leaky Gaussian Error Linear Unit (GELU) function is used in the upsampling module as the activation function.

In some embodiments, residual blocks are added to the upsampling module. In this way, it can exact information of subbands and result in a deeper structure.

In some embodiments, the residual blocks are added to all upsampling blocks. Alternatively, a residual block is implemented, and an attention module is added in a layer. In this way, it can enhance the exaction capability of the network.

In some embodiments, sub-pixel convolution layers are used in upsampling operation. In some other embodiments, transposed convolution layers are used in the upsampling operation.

In some embodiments, a GDN layer is added to the upsampling module. In some other embodiments, a leaky ReLU function is used in the upsampling module as activation function. In some further embodiments, a leaky GELU function is used in the upsampling module as activation function.

In some embodiments, the numbers of channels increase during the resizing operation, and the number of output feature map channels of the resized subbands are (16, 16, 16, 32). In some embodiments, the upsampling module comprises convolution layers and an activation function. In this way, it can reduce the complexity.

In some embodiments, sub-pixel convolution layers are used in upsampling operation. Alternatively, transposed convolution layers are used in the upsampling operation.

In some embodiments, a generalized divisive normalization (GDN) layer is added to the upsampling module. In some other embodiments, a leaky ReLU function is used in the upsampling module as the activation function. In some further embodiments, a GELU function is used in the upsampling module as the activation function.

In some embodiments, residual blocks are added to the upsampling module. In this way, it can extract information of subbands and result in a deeper structure. For example, the residual blocks are added to all upsampling blocks. Alternatively, a residual block is implemented, and an attention module is added in a layer. In this way, it can enhance the exaction capability of the network.

In some embodiments, sub-pixel convolution layers are used in upsampling operation. In some other embodiments, transposed convolution layers are used in the upsampling operation.

In some embodiments, a GDN layer is added to the upsampling module. In some other embodiments, a leaky ReLU function is used in the upsampling module as activation function. In some further embodiments, a leaky GELU function is used in the upsampling module as activation function.

In some embodiments, subbands with larger sizes than other subbands in the plurality of subbands are resized by downsampling module to a smallest spatial resolution. For example, the numbers of channels increase with a ratio of downsampling, and the number of output channels of the resized subbands comprises an incremental sequence corresponding to a size of input subbands. In some embodiments, weights of downsampling modules are independent, each downsampling module is designed to process a target size of subbands, and different structures of downsampling modules are applied dependent on a unique feature of the subbands.

In some embodiments, an attention block is added in different order, and an input channel number of the attention block varies in different downsampling modules. In some other embodiments, in each downsampling module, output channels vary after each residual block with stride 2.

In some embodiments, weights and structure of downsampling modules are shared, if the downsampling modules have similar function and operation on different subbands, weights of downsampling modules processing small subbands are reused in the downsampling of larger subbands, and the output channel numbers of downsampling are (32, 48, 144, 576). For example, a function of downsampling structure is changed.

In some embodiments, a GDN layer is added in a downsampling module processing smallest subbands. Alternatively, different numbers of GDN and convolution layers are added in different downsampling modules.

In some embodiments, a structure of merging-and-decorrelation module after the downsampling operation is changed. For example, more attention blocks are added in a structure of merging-and-decorrelation module after a downsampling operation. Alternatively, GDN layers are added between residual blocks.

In some embodiments, output channel numbers of first and second largest subbands are reduced. For example, weights of downsampling modules are independent, each downsampling module is designed for a target size of subbands, and different structures of downsampling modules are applied depending on a unique feature of the subbands.

In some embodiments, an attention block is added in different order, and an input channel number of the attention block varies in different downsampling modules. In some other embodiments, in each downsampling module, output channels vary after each residual block with stride 2.

In some embodiments, weights and structure of downsampling modules are shared, if the downsampling modules have similar function and operation on different subbands, weights of downsampling modules processing small subbands are reused in the downsampling of larger subbands. For example, different operations are performed on first and second largest subbands.

In some embodiments, a structure of the downsampling module is kept on the second largest subband and an output channel number of the first largest subband is reduced, and the output channel numbers of downsampling module are (36,36,192,192). In some other embodiments, a radical reduction on output channels is applied to downsampling modules, and output channel numbers of downsampling modules are (36,36,144,192).

In some embodiments, a structure of merging-and-decorrelation module is changed. For example, more attention blocks and more residual blocks are added in the structure of merging-and-decorrelation module. In some embodiments, more generalized divisive normalization layers re added between residual blocks.

In some embodiments, output channel numbers of smaller subbands are increased while output channel numbers of lager subbands are reduced. In one example, given that smaller subbands carry more low-frequency information which is more significant to image compression compared with the high-frequency information carried by the larger subbands. Thus, smaller subbands' output channel number can be increased while the output channel number of the lager subbands can be reduced.

In some embodiments, weights of downsampling modules are independent, each downsampling module is designed for a target size of subbands, different structures of downsampling modules are applied depending on a unique feature of the subbands. For example, an attention block is added in different order, and an input channel number of the attention block varies in different downsampling modules. As another example, in each downsampling module, output channels vary after each residual block with stride 2.

In some embodiments, weights and structure of downsampling modules are shared, if the downsampling modules have similar function and operation on different subbands, weights of downsampling modules processing small subbands are fully or partially reused in the downsampling of larger subbands. For example, different approaches are adopted on different downsampling modules. In some embodiments, both increase and decrease in output channel numbers are mild, output channels of different modules comprise an incremental sequence corresponding to a size of input subbands overall. In some other embodiments, a radical change on all downsampling modules, output channel numbers of downsampling modules are same, and the output channel numbers of downsampling modules are (192,192,192,192).

In some embodiments, a structure of merging-and-decorrelation module is changed. In one example, the structure of merging-and-decorrelation network can be enhanced since the downsampling blocks may be simplified.

In some embodiments, another approach is to process the plurality of subbands by a descending order of their sizes where a largest subband, after first go through an embedding model and downsampling module, is combined with an embedded second largest subband and fed to a next downsampling module, an ultimate module remove a correlation in channel dimension and modify channel number. In some embodiments, output channel numbers of downsampling modules are fixed. For example, the output channel numbers of downsampling modules are (192,192,192,192).

In some embodiments, output channel numbers of downsampling modules increase as more embeded subbands are spliced to the output. For example, the output channel numbers of downsampling modules are (192,224,256,288).

In some embodiments, for a latent feature that obtained after the entropy coding, all subbands are reconstructed though the resizing operation, the latent feature are firstly processed by non-linear up-transformation and split to different subbands in channel dimension and then goes through corresponding upsampling modules. In some embodiments, a downsampling module is used in resizing operation in decoder. In some embodiments, the numbers of channels remain unchanged during the resizing operation, and output channel numbers of downsampling module are (9, 9, 9, 12).

In some embodiments, the downsampling module comprises convolution layers and an activation function. In some embodiments, an inverse generalized divisive normalization (iGDN) layer is added to the downsampling module. In some other embodiments, a leaky ReLU function is used in the downsampling module as the activation function. In some further embodiments, a leaky Gaussian Error Linear Unit (GELU) function is used in the downsampling module as the activation function.

In some embodiments, residual blocks are added to the downsampling module. For example, the residual blocks are added to all downsampling blocks. Alternatively, a residual block is implemented, and an attention module is added in a layer.

In some embodiments, an iGDN layer is added to the downsampling module. In some other embodiments, a leaky ReLU function is used in the downsampling module as activation function. In some further embodiments, a leaky GELU function is used in the downsampling module as activation function.

In some embodiments, the numbers of channels remain unchanged during the resizing operation, and output channel numbers of different downsampling modules are different. For example, the downsampling module comprises convolution layers and an activation function. In some embodiments, an iGDN layer is added to the downsampling module. In some other embodiments, a leaky ReLU function is used in the downsampling module as the activation function. In some further embodiments, a GELU function is used in the downsampling module as the activation function.

In some embodiments, residual blocks are added to the downsampling module. For example, the residual blocks are added to all downsampling blocks. Alternatively, a residual block is added in a target downsampling module.

In some embodiments, an iGDN layer is added to the downsampling module. In some other embodiments, a leaky ReLU function is used in the downsampling module as activation function. In some further embodiments, a leaky GELU function is used in the downsampling module as activation function.

In some embodiments, an upsampling module is used in a resizing operation in decoder. In some embodiments, the numbers of channels increase with a ratio of upsampling, and the number of output channels of the resized subbands comprises an incremental sequence corresponding to a size of input latent samples. For example, weights of upsampling modules are independent, each upsampling module is designed to process a latent feature with a target channel number, and different structures of upsampling modules are applied dependent on a unique feature of input.

In some embodiments, attention block is added in different order, and an input channel number of the attention block varies in different upsampling modules. In some other embodiments, in each upsampling module, output channels vary after each residual block with stride 2.

In some embodiments, weights and structure of upsampling modules are shared, if the upsampling modules have similar function and operation on different inputs, weights of upsampling modules processing subbands with small channel number are reused in the upsampling of larger subbands, and the input channel numbers of upsampling are (32, 48, 144, 576). In some embodiments, a function of upsampling structure is changed. For example, an iGDN layer is added in an upsampling module processing smallest inputs. Alternatively, different numbers of iGDN and convolution layers are added in different upsampling modules.

In some embodiments, a structure of up-transformation module after the upsampling operation is changed. For example, more attention blocks are added in the structure of up-transformation module after the upsampling operation. Alternatively, iGDN layers are added between residual blocks.

In some embodiments, input channel numbers corresponding to first and second largest subbands are reduced. For example, weights of upsampling modules are independent, each upsampling module is designed for a target size of subbands, and different structures of upsampling modules are applied depending on a unique feature of the subbands.

In some embodiments, an attention block is added in different order, and an input channel number of the attention block varies in different upsampling modules. In some other embodiments, in each upsampling module, output channels vary after each residual block with stride 2.

In some embodiments, weights and structure of upsampling modules are shared, if the upsampling modules have similar function and operation on different subbands, weights of upsampling modules processing subbands with smaller channel number are reused in the upsampling of larger subbands. For example, different operations are performed on first and second largest subbands.

In some embodiments, a structure of the upsampling module is kept on the second largest subband and an output channel number of the first largest subband is reduced, and the input channel numbers of upsampling module are (36,36,192,192). In some other embodiments, a radical reduction on input channels is applied to upsampling modules, and input channel numbers of upsampling modules are (36,36,144,192).

In some embodiments, a structure of up-transformation module is changed. In some embodiments, more attention blocks and more residual blocks are added in the structure of up-transformation module. In some other embodiments, more inverse generalized divisive normalization layers re added between residual blocks.

In some embodiments, input channel numbers corresponding to smaller subbands are increased while input channel numbers of lager subbands are reduced. For example, weights of upsampling modules are independent, each upsampling module is designed for a target size of subbands, different structures of upsampling modules are applied depending on a unique feature of the subbands.

In some embodiments, an attention block is added in different order, and an input channel number of the attention block varies in different upsampling modules. In some other embodiments, in each upsampling module, output channels vary after each residual block with stride 2.

In some embodiments, weights and structure of upsampling modules are shared, if the upsampling modules have similar function and operation on different subbands, weights of upsampling modules used in a processing of small subbands are fully or partially reused in the upsampling of larger subbands. For example, different approaches are adopted on different upsampling modules.

In some embodiments, both increase and decrease in input channel numbers are mild, output channels of different modules comprise an incremental sequence corresponding to a size of input subbands overall. In some other embodiments, a radical change on all upsampling modules, input channel numbers of upsampling modules are same, and the output channel numbers of downsampling modules are (192,192,192,192). In some embodiments, a structure of up-transformation module is changed.

In some embodiments, another approach is to process the plurality of subbands by a descending order of their sizes where a latent feature first goes through an upsampling module and then is split to two parts, the following operation is repeated till all subbands are reconstructed: a bigger part is fed to a next upsampling module while a smaller part becomes a subband after the resize operation. In some embodiments, output channel numbers of upsampling modules are fixed. For example, the output channel numbers of upsampling modules are (192,192,192,192).

In some embodiments, output channel numbers of upsampling modules increase as more embeded subbands are split from the input. For example, the input channel numbers of upsampling modules are (288,256,224,192).

In some embodiments, visual data is processed by the wavelet-based transform module and transformed to a predetermined number of subbands of four different spatial resolutions, each subband is reshaped by their own downsampling modules to get a same target size, all subbands go through a merging and decorrelation module, and processed latent features are encoded by an entropy encoding module to obtain the bitstream. An example is shown in FIG. 11.

In some embodiments, an input feature is processed with 4 individual branch to obtain 4 group information depending on their spatial resolution, and downsampling modules comprise a downsampling module with a single residual block and a downsampling module with a single residual block followed by a residual block with stride. An example is shown in FIG. 12.

In some embodiments, after all subbands are processed to a same spatial resolution, the processed subbands are fed to a merge and decorrelation block that comprises one or more of a residual block, an attention block or a convolution layer. For example, the merge and decorrelation module comprises a single residual block, an attention block, and a convolution layer with kernel size being 3 and stride 1. An example is shown in FIG. 13.

In some embodiments, in a decoding process, the bitstream is decoded by an entropy decoding module and a quantized latent representation is obtained by obtaining its samples, the latent representation is processed by up-transformation to exact feature and increase channel number, the latent feature is then split to a predetermined number subbans for different channel numbers, each subband is reshaped by their own upsampling modules to get different spatial resolutions, the subbands of different sizes are fed to a four-step inverse transformation in wavelet-like module. An example is shown in FIG. 14.

In some embodiments, an input feature is processed with 4 individual branch to obtain 4 group information depending on their spatial resolution, and upsampling modules comprise an upsampling module with a single residual block and an upsampling module with a single residual block followed by a residual block with stride. An example is shown in FIG. 15.

In some embodiments, after quantized latent samples are obtained, the quantized latent samples are fed to a merge and decorrelation block that comprises one or more of a residual block, an attention block or a convolution layer. For example, the up-transformation module comprises a single residual block, an attention block, or a convolution layer with kernel size being 3 and stride 1. An example is shown in FIG. 16.

In some embodiments, the visual data is processed by the wavelet-based transform module and transformed to a predetermined number of subbands of four different spatial resolutions, each subband is reshaped by upsampling modules to get a same target size, all subbands go through a merging and decorrelation module, processed latent features are encoded by an entropy encoding module to obtain the bitstream. An example is shown in FIG. 17.

In some embodiments, an input feature is processed with individual branchs to obtain 4 group information depending on their spatial resolution. For example, an upsampling module comprises an upsampling block with a subpixel layer followed by leaky ReLU layer. An example is shown in FIG. 18.

In some embodiments, after all subbands are processed to a same spatial resolution, the processed subbands are fed to a merge and decorrelation block that comprises one or more of a residual block, an attention block or a convolution layer. For example, the merge and decorrelation module comprises a single residual block, an attention block, a convolution layer with kernel size being 3 and stride 1, and a downsampling module with a single residual block followed by a residual block with stride. An example is shown in FIG. 19.

In some embodiments, in a decoding process, the bitstream is decoded by an entropy decoding module and a quantized latent representation is obtained by obtaining its samples, the latent representation is processed by inverse transformation to exact feature and increase channel number, the latent feature is then split to a predetermined number subbans for different channel numbers, each subband is reshaped by their own downsampling modules to get different spatial resolutions, the subbands of different sizes are fed to a four-step inverse transformation in wavelet-like module. An example is shown in FIG. 20.

In some embodiments, an input feature is processed with 4 individual branch to obtain 4 group information depending on their channel number, and dowmsampling modules comprise a dowmsampling module with a single convolution layer and leaky ReLU. An example is shown in FIG. 21.

In some embodiments, after quantized latent samples are obtained, the quantized latent samples are fed to a transformation block that comprises one or more of a residual block, an attention block or a convolution layer. For example, the up-transformation module comprises a single residual block, an attention block, or a convolution layer with kernel size being 3 and stride 1. An example is shown in FIG. 22.

In some embodiments, a neural network structure comprises an attention block, a residual downsample block, a residual unit, a residual block and a residual upsample block. In some embodiments, the residual block comprises convolution layers, a leaky ReLU and a residual connection. In some embodiments, based on the residual block, another ReLU layer is added to the residual unit to get a final output. In some embodiments, the attention block comprises two branches and a residual connection. In some embodiments, the two branches have a residual unit and a convolution layer. In some embodiments, the residual downsample block comprises a convolution layer with stride2, a leaky ReLU, a convolution layer with stride 1, and a generalized divisive normalization (GDN). In some embodiments, the residual downsample block comprises a 2-stride convolution layer in its residual connection. In some embodiments, the residual upsample block comprises a convolution layer with stride2, a leaky ReLU, a convolution layer with stride 1, and an inverse generalized divisive normalization (iGDN). In some embodiments, the residual upsample block comprises a 2-stride convolution layer in its residual connection. An example is shown in FIG. 23.

According to further embodiments of the present disclosure, a non-transitory computer-readable recording medium is provided. The non-transitory computer-readable recording medium stores a bitstream of visual data which is generated by a method performed by an apparatus for visual data processing. The method includes determining a wavelet-based transform module and a resizing operation; and generating the bitstream based on the wavelet-based transform module and the resizing operation.

According to still further embodiments of the present disclosure, a method for storing bitstream of a video is provided. The method includes determining a wavelet-based transform module and a resizing operation; generating the bitstream based on the wavelet-based transform module and the resizing operation; and storing the bitstream in a non-transitory computer-readable recording medium.

Implementations of the present disclosure can be described in view of the following clauses, the features of which can be combined in any reasonable manner.

Clause 1. A method for video processing, comprising: determining, for a conversion between a visual data and a bitstream of the visual data, a wavelet-based transform module and a resizing operation; and performing the conversion based on the wavelet-based transform module and the resizing operation.

Clause 2. The method of Clause 1, wherein performing the conversion comprises: obtaining a plurality subbands of the visual data transforming the visual data using the wavelet-based transform module; applying the resizing operation to at least one subband of the plurality of subbands; and obtaining the bitstream by applying an entropy coding to the plurality of subbands after the resizing operation; or wherein performing the conversion comprises: obtaining a plurality subbands of the visual data by applying an entropy decoding to the bitstream; applying the resizing operation to at least one subband of the plurality of subbands; and applying a transforming operation on the plurality of subbands after the resizing operation using the wavelet-based transform module.

Clause 3. The method of Clause 2, wherein sizes of the plurality of subbands comprise one of:

$$\frac{W}{2} \times \frac{H}{2} and \frac{W}{4} \times \frac{H}{4} , or \frac{W}{2} \times \frac{H}{2} \frac{W}{4} \times \frac{H}{4} , and \frac{W}{8} \times \frac{H}{8} , or \frac{W}{2} \times \frac{H}{2} \frac{W}{4} \times \frac{H}{4} , \frac{W}{8} \times \frac{H}{8} and , \frac{W}{16} \times \frac{H}{16} ,$$

and wherein H and W relate to a size of the visual data or a reconstructed visual data, and the number of subbands is dependent on transformation times of the wavelet.

Clause 4. The method of Clause 3, wherein H is a height of the visual data or the reconstructed visual data, and/or wherein W is a width of the input visual data or the reconstructed visual data.

Clause 5. The method of any of Clauses 1-4, wherein the resizing operation comprises a downsampling or an upsampling operation.

Clause 6. The method of any of Clauses 1-4, wherein the resizing operation comprises a downsampling operation in an encoder and an upsampling operation in a decoder.

Clause 7. The method of any of Clauses 1-4, wherein the resizing operation comprises an upsampling operation in an encoder and a downsampling operation in a decoder.

Clause 8. The method of any of Clauses 1-7, wherein the resizing operation is performed by a neural network.

Clause 9. The method of Clause 8, wherein the neural network used to perform the resizing operation comprises at least one of: a deconvolution layer, a convolution layer, an attention module, a residual block, an activation layer, a leaky rectified linear unit (ReLU) layer, a ReLU layer, or a normalization layer.

Clause 10. The method of any of Clauses 1-9, wherein the resizing operation is performed on a subset of the plurality of subbands, or wherein the resizing operation is performed on all subbands of the plurality of subbands.

Clause 11. The method of any of Clauses 1-9, wherein the resizing operation is performed according to a target size.

Clause 12. The method of Clause 11, wherein the target size is equal to a size of a biggest subband, or wherein the target size is equal to a size of a smallest subband, or wherein the target size is equal to

$$\frac{W}{2} \times \frac{H}{2} , or \frac{W}{4} \times \frac{H}{4} , or \frac{W}{8} \times \frac{H}{8} , or \frac{W}{16} \times \frac{H}{16} ,$$

wherein H and W relate to a size of the visual data or a reconstructed visual data.

Clause 13. The method of any of Clauses 1-12, wherein the resizing is performed on a subset of the plurality of subbands for a plurality of times by using different resizing operation.

Clause 14. The method of any of Clauses 1-13, wherein different resizing operations are performed on different subbands.

Clause 15. The method of any of Clauses 1-14, wherein a subset of subbands of the plurality of subbands are combined in channel dimension before a processing of the resizing.

Clause 16. The method of any of Clauses 1-15, wherein obtaining the plurality of subbands by applying the entropy decoding on the bitstream comprises at least one of: obtaining a latent representation by applying the entropy decoding to the bitstream; or dividing the latent representation into at least two divisions, wherein a first division is corresponding to a first subband of the plurality of subbands, and a second division is corresponding to a second subband of the plurality of subbands.

Clause 17. The method of Clause 16, wherein the division of the latent representation is channel wise, or in dimension of feature maps.

Clause 18. The method of Clause 17, wherein the latent representation comprises 3 dimensions including a width, a height and a third dimensions that represents number of channels or number of feature maps.

Clause 19. The method of Clause 18, wherein the division is based on at least one target channel number, wherein the channel number represents a size of the third dimension of the latent representation.

Clause 20. The method of Clause 16, wherein a size of the latent representation is C, W and H, wherein W represents a width, H represents a height, and C represents number of channels or number of feature maps.

Clause 21. The method of Clause 20, wherein the latent representation is divided into at least 2 subbands, wherein a size of the first subband is C1, which is smaller than C.

Clause 22. The method of Clause 16, wherein the latent representation is divided into predetermined number of channels.

Clause 23. The method of any of Clauses 1-15, wherein obtaining the bitstream by applying the entropy coding to the plurality of subbands after the resizing operation comprises: concatenating the plurality of subbands into a latent representation.

Clause 24. The method of Clause 23, wherein the concatenation is performed in channel dimension, wherein if sizes of a first subband and a subband after resizing are C1, H, W and C2, H, W respectively, a size of the latent representation is C1+C2, H, W.

Clause 25. The method of any of Clauses 1-24, wherein if N levels of wavelet-like forward transformations are applied to the visual data, a group of subbands with N spatial sizes are generated, N downsampling modules with different downsampling factors are used to process the group of subbands, and the N downsampling modules are used to unify all subbands in spatial dimensions, wherein N is an integer number.

Clause 26. The method of Clause 25, wherein for subbands that obtained after the wavelet tranformation, all subbands are put together though the resizing operation.

Clause 27. The method of any of Clauses 1-26, wherein subbands with smaller sizes than other subbands in the plurality of subbands are resized by upsampling module to a largest spatial resolution.

Clause 28. The method of Clause 27, wherein the numbers of channels remain unchanged during the resizing operation, and the number of output feature map channels of the resized subbands are (9, 9, 9, 12).

Clause 29. The method of Clause 28, wherein the upsampling module comprises convolution layers and an activation function.

Clause 30. The method of Clause 29, wherein sub-pixel convolution layers are used in upsampling operation, or wherein transposed convolution layers are used in the upsampling operation.

Clause 31. The method of Clause 30, wherein a generalized divisive normalization (GDN) layer is added to the upsampling module.

Clause 32. The method of Clause 30, wherein a leaky ReLU function is used in the upsampling module as the activation function.

Clause 33. The method of Clause 30, wherein a leaky Gaussian Error Linear Unit (GELU) function is used in the upsampling module as the activation function.

Clause 34. The method of Clause 28, wherein residual blocks are added to the upsampling module.

Clause 35. The method of Clause 34, wherein the residual blocks are added to all upsampling blocks, or wherein a residual block is implemented, and an attention module is added in a layer.

Clause 36. The method of Clause 35, wherein sub-pixel convolution layers are used in upsampling operation, or wherein transposed convolution layers are used in the upsampling operation.

Clause 37. The method of Clause 36, wherein a GDN layer is added to the upsampling module.

Clause 38. The method of Clause 36, wherein a leaky ReLU function is used in the upsampling module as activation function.

Clause 39. The method of Clause 36, wherein a leaky GELU function is used in the upsampling module as activation function.

Clause 40. The method of Clause 27, wherein the numbers of channels increase during the resizing operation, and the number of output feature map channels of the resized subbands are (16, 16, 16, 32).

Clause 41. The method of Clause 40, wherein the upsampling module comprises convolution layers and an activation function.

Clause 42. The method of Clause 41, wherein sub-pixel convolution layers are used in upsampling operation, or wherein transposed convolution layers are used in the upsampling operation.

Clause 43. The method of Clause 42, wherein a generalized divisive normalization (GDN) layer is added to the upsampling module.

Clause 44. The method of Clause 42, wherein a leaky ReLU function is used in the upsampling module as the activation function.

Clause 45. The method of Clause 42, wherein a GELU function is used in the upsampling module as the activation function.

Clause 46. The method of Clause 40, wherein residual blocks are added to the upsampling module.

Clause 47. The method of Clause 46, wherein the residual blocks are added to all upsampling blocks, or wherein a residual block is implemented, and an attention module is added in a layer.

Clause 48. The method of Clause 47, wherein sub-pixel convolution layers are used in upsampling operation, or wherein transposed convolution layers are used in the upsampling operation.

Clause 49. The method of Clause 48, wherein a GDN layer is added to the upsampling module.

Clause 50. The method of Clause 48, wherein a leaky ReLU function is used in the upsampling module as activation function.

Clause 51. The method of Clause 48, wherein a leaky GELU function is used in the upsampling module as activation function.

Clause 52. The method of any of Clauses 1-26, wherein subbands with larger sizes than other subbands in the plurality of subbands are resized by downsampling module to a smallest spatial resolution.

Clause 53. The method of Clause 52, wherein the numbers of channels increase with a ratio of downsampling, and the number of output channels of the resized subbands comprises an incremental sequence corresponding to a size of input subbands.

Clause 54. The method of Clause 53 wherein weights of downsampling modules are independent, each downsampling module is designed to process a target size of subbands, and different structures of downsampling modules are applied dependent on a unique feature of the subbands.

Clause 55. The method of Clause 54, wherein an attention block is added in different order, and an input channel number of the attention block varies in different downsampling modules.

Clause 56. The method of Clause 54, wherein in each downsampling module, output channels vary after each residual block with stride 2.

Clause 57. The method of Clause 53, wherein weights and structure of downsampling modules are shared, if the downsampling modules have similar function and operation on different subbands, weights of downsampling modules processing small subbands are reused in the downsampling of larger subbands, and the output channel numbers of downsampling are (32, 48, 144, 576).

Clause 58. The method of Clause 57, wherein a function of downsampling structure is changed.

Clause 59. The method of Clause 58, wherein a GDN layer is added in a downsampling module processing smallest subbands, or wherein different numbers of GDN and convolution layers are added in different downsampling modules.

Clause 60. The method of Clause 57, wherein a structure of merging-and-decorrelation module after the downsampling operation is changed.

Clause 61. The method of Clause 60, wherein more attention blocks are added in a structure of merging-and-decorrelation module after a downsampling operation, or wherein GDN layers are added between residual blocks.

Clause 62. The method of Clause 52, wherein output channel numbers of first and second largest subbands are reduced.

Clause 63. The method of Clause 62 wherein weights of downsampling modules are independent, each downsampling module is designed for a target size of subbands, and different structures of downsampling modules are applied depending on a unique feature of the subbands.

Clause 64. The method of Clause 63, wherein an attention block is added in different order, and an input channel number of the attention block varies in different downsampling modules.

Clause 65. The method of Clause 63, wherein in each downsampling module, output channels vary after each residual block with stride 2.

Clause 66. The method of Clause 62, wherein weights and structure of downsampling modules are shared, if the downsampling modules have similar function and operation on different subbands, weights of downsampling modules processing small subbands are reused in the downsampling of larger subbands.

Clause 67. The method of Clause 66, wherein different operations are performed on first and second largest subbands.

Clause 68. The method of Clause 67, wherein a structure of the downsampling module is kept on the second largest subband and an output channel number of the first largest subband is reduced, and the output channel numbers of downsampling module are (36,36,192,192).

Clause 69. The method of Clause 67, wherein a radical reduction on output channels is applied to downsampling modules, and output channel numbers of downsampling modules are (36,36,144,192).

Clause 70. The method of Clause 66, wherein a structure of merging-and-decorrelation module is changed.

Clause 71. The method of Clause 70, wherein more attention blocks and more residual blocks are added in the structure of merging-and-decorrelation module.

Clause 72. The method of Clause 70, wherein more generalized divisive normalization layers re added between residual blocks.

Clause 73. The method of Clause 52, wherein output channel numbers of smaller subbands are increased while output channel numbers of lager subbands are reduced.

Clause 74. The method of Clause 73, wherein weights of downsampling modules are independent, each downsampling module is designed for a target size of subbands, different structures of downsampling modules are applied depending on a unique feature of the subbands.

Clause 75. The method of Clause 74, wherein an attention block is added in different order, and an input channel number of the attention block varies in different downsampling modules.

Clause 76. The method of Clause 74, wherein in each downsampling module, output channels vary after each residual block with stride 2.

Clause 77. The method of Clause 73, wherein weights and structure of downsampling modules are shared, if the downsampling modules have similar function and operation on different subbands, weights of downsampling modules processing small subbands are fully or partially reused in the downsampling of larger subbands.

Clause 78. The method of Clause 77, wherein different approaches are adopted on different downsampling modules.

Clause 79. The method of Clause 78, wherein both increase and decrease in output channel numbers are mild, output channels of different modules comprise an incremental sequence corresponding to a size of input subbands overall.

Clause 80. The method of Clause 78, wherein a radical change on all downsampling modules, output channel numbers of downsampling modules are same, and the output channel numbers of downsampling modules are (192,192,192,192).

Clause 81. The method of Clause 77, wherein a structure of merging-and-decorrelation module is changed.

Clause 82. The method of Clause 52, wherein another approach is to process the plurality of subbands by a descending order of their sizes where a largest subband, after first go through an embedding model and downsampling module, is combined with an embedded second largest subband and fed to a next downsampling module, an ultimate module remove a correlation in channel dimension and modify channel number.

Clause 83. The method of Clause 82, wherein output channel numbers of downsampling modules are fixed.

Clause 84. The method of Clause 83, wherein the output channel numbers of downsampling modules are (192,192,192,192).

Clause 85. The method of Clause 82, wherein output channel numbers of downsampling modules increase as more embeded subbands are spliced to the output.

Clause 86. The method of Clause 85, wherein the output channel numbers of downsampling modules are (192,224,256,288).

Clause 87. The method of any of Clauses 1-86, wherein for a latent feature that obtained after the entropy coding, all subbands are reconstructed though the resizing operation, the latent feature are firstly processed by non-linear up-transformation and split to different subbands in channel dimension and then goes through corresponding upsampling modules.

Clause 88. The method of any of Clauses 1-87, wherein a downsampling module is used in resizing operation in decoder.

Clause 89. The method of Clause 88, wherein the numbers of channels remain unchanged during the resizing operation, and output channel numbers of downsampling module are (9, 9, 9, 12).

Clause 90. The method of Clause 89, wherein the downsampling module comprises convolution layers and an activation function.

Clause 91. The method of Clause 90, wherein an inverse generalized divisive normalization (iGDN) layer is added to the downsampling module.

Clause 92. The method of Clause 90, wherein a leaky ReLU function is used in the downsampling module as the activation function.

Clause 93. The method of Clause 90, wherein a leaky Gaussian Error Linear Unit (GELU) function is used in the downsampling module as the activation function.

Clause 94. The method of Clause 89, wherein residual blocks are added to the downsampling module.

Clause 95. The method of Clause 94, wherein the residual blocks are added to all downsampling blocks, or wherein a residual block is implemented, and an attention module is added in a layer.

Clause 96. The method of Clause 95, wherein an iGDN layer is added to the downsampling module.

Clause 97. The method of Clause 95, wherein a leaky ReLU function is used in the downsampling module as activation function.

Clause 98. The method of Clause 95, wherein a leaky GELU function is used in the downsampling module as activation function.

Clause 99. The method of Clause 88, wherein the numbers of channels remain unchanged during the resizing operation, and output channel numbers of different downsampling modules are different.

Clause 100. The method of Clause 99, wherein the downsampling module comprises convolution layers and an activation function.

Clause 101. The method of Clause 100, wherein an iGDN layer is added to the downsampling module.

Clause 102. The method of Clause 100, wherein a leaky ReLU function is used in the downsampling module as the activation function.

Clause 103. The method of Clause 100, wherein a GELU function is used in the downsampling module as the activation function.

Clause 104. The method of Clause 99, wherein residual blocks are added to the downsampling module.

Clause 105. The method of Clause 104, wherein the residual blocks are added to all downsampling blocks, or wherein a residual block is added in a target downsampling module.

Clause 106. The method of Clause 105, wherein an iGDN layer is added to the downsampling module.

Clause 107. The method of Clause 105, wherein a leaky ReLU function is used in the downsampling module as activation function.

Clause 108. The method of Clause 105, wherein a leaky GELU function is used in the downsampling module as activation function.

Clause 109. The method of any of Clauses 1-87, wherein an upsampling module is used in a resizing operation in decoder.

Clause 110. The method of Clause 109, wherein the numbers of channels increase with a ratio of upsampling, and the number of output channels of the resized subbands comprises an incremental sequence corresponding to a size of input latent samples.

Clause 111. The method of Clause 110, wherein weights of upsampling modules are independent, each upsampling module is designed to process a latent feature with a target channel number, and different structures of upsampling modules are applied dependent on a unique feature of input.

Clause 112. The method of Clause 111, wherein an attention block is added in different order, and an input channel number of the attention block varies in different upsampling modules.

Clause 113. The method of Clause 111, wherein in each upsampling module, output channels vary after each residual block with stride 2.

Clause 114. The method of Clause 110, wherein weights and structure of upsampling modules are shared, if the upsampling modules have similar function and operation on different inputs, weights of upsampling modules processing subbands with small channel number are reused in the upsampling of larger subbands, and the input channel numbers of upsampling are (32, 48, 144, 576).

Clause 115. The method of Clause 114, wherein a function of upsampling structure is changed.

Clause 116. The method of Clause 115, wherein an iGDN layer is added in an upsampling module processing smallest inputs, or wherein different numbers of iGDN and convolution layers are added in different upsampling modules.

Clause 117. The method of Clause 114, wherein a structure of up-transformation module after the upsampling operation is changed.

Clause 118. The method of Clause 117, wherein more attention blocks are added in the structure of up-transformation module after the upsampling operation, or wherein iGDN layers are added between residual blocks.

Clause 119. The method of Clause 109, wherein input channel numbers corresponding to first and second largest subbands are reduced.

Clause 120. The method of Clause 119, wherein weights of upsampling modules are independent, each upsampling module is designed for a target size of subbands, and different structures of upsampling modules are applied depending on a unique feature of the subbands.

Clause 121. The method of Clause 120, wherein an attention block is added in different order, and an input channel number of the attention block varies in different upsampling modules.

Clause 122. The method of Clause 120, wherein in each upsampling module, output channels vary after each residual block with stride 2.

Clause 123. The method of Clause 119, wherein weights and structure of upsampling modules are shared, if the upsampling modules have similar function and operation on different subbands, weights of upsampling modules processing subbands with smaller channel number are reused in the upsampling of larger subbands.

Clause 124. The method of Clause 123, wherein different operations are performed on first and second largest subbands.

Clause 125. The method of Clause 124, wherein a structure of the upsampling module is kept on the second largest subband and an output channel number of the first largest subband is reduced, and the input channel numbers of upsampling module are (36,36,192,192).

Clause 126. The method of Clause 124, wherein a radical reduction on input channels is applied to upsampling modules, and input channel numbers of upsampling modules are (36,36,144,192).

Clause 127. The method of Clause 123, wherein a structure of up-transformation module is changed.

Clause 128. The method of Clause 127, wherein more attention blocks and more residual blocks are added in the structure of up-transformation module.

Clause 129. The method of Clause 127, wherein more inverse generalized divisive normalization layers re added between residual blocks.

Clause 130. The method of Clause 109, wherein input channel numbers corresponding to smaller subbands are increased while input channel numbers of lager subbands are reduced.

Clause 131. The method of Clause 130, wherein weights of upsampling modules are independent, each upsampling module is designed for a target size of subbands, different structures of upsampling modules are applied depending on a unique feature of the subbands.

Clause 132. The method of Clause 131, wherein an attention block is added in different order, and an input channel number of the attention block varies in different upsampling modules.

Clause 133. The method of Clause 131, wherein in each upsampling module, output channels vary after each residual block with stride 2.

Clause 134. The method of Clause 130, wherein weights and structure of upsampling modules are shared, if the upsampling modules have similar function and operation on different subbands, weights of upsampling modules used in a processing of small subbands are fully or partially reused in the upsampling of larger subbands.

Clause 135. The method of Clause 134, wherein different approaches are adopted on different upsampling modules.

Clause 136. The method of Clause 135, wherein both increase and decrease in input channel numbers are mild, output channels of different modules comprise an incremental sequence corresponding to a size of input subbands overall.

Clause 137. The method of Clause 135, wherein a radical change on all upsampling modules, input channel numbers of upsampling modules are same, and the output channel numbers of downsampling modules are (192,192,192,192).

Clause 138. The method of Clause 134, wherein a structure of up-transformation module is changed.

Clause 139. The method of Clause 109, wherein another approach is to process the plurality of subbands by a descending order of their sizes where a latent feature first goes through an upsampling module and then is split to two parts, the following operation is repeated till all subbands are reconstructed: a bigger part is fed to a next upsampling module while a smaller part becomes a subband after the resize operation.

Clause 140. The method of Clause 139, wherein output channel numbers of upsampling modules are fixed.

Clause 141. The method of Clause 140, wherein the output channel numbers of upsampling modules are (192,192,192,192).

Clause 142. The method of Clause 139, wherein output channel numbers of upsampling modules increase as more embeded subbands are split from the input.

Clause 143. The method of Clause 142, wherein the input channel numbers of upsampling modules are (288,256,224,192).

Clause 144. The method of Clause 1, wherein the visual data is processed by the wavelet-based transform module and transformed to a predetermined number of subbands of four different spatial resolutions, each subband is reshaped by their own downsampling modules to get a same target size, all subbands go through a merging and decorrelation module, and processed latent features are encoded by an entropy encoding module to obtain the bitstream.

Clause 145. The method of Clause 1, wherein an input feature is processed with 4 individual branch to obtain 4 group information depending on their spatial resolution, and downsampling modules comprise a downsampling module with a single residual block and a downsampling module with a single residual block followed by a residual block with stride.

Clause 146. The method of Clause 1, wherein after all subbands are processed to a same spatial resolution, the processed subbands are fed to a merge and decorrelation block that comprises one or more of a residual block, an attention block or a convolution layer.

Clause 147. The method of Clause 146, wherein the merge and decorrelation module comprises a single residual block, an attention block, and a convolution layer with kernel size being 3 and stride 1.

Clause 148. The method of Clause 1, wherein in a decoding process, the bitstream is decoded by an entropy decoding module and a quantized latent representation is obtained by obtaining its samples, the latent representation is processed by up-transformation to exact feature and increase channel number, the latent feature is then split to a predetermined number subbans for different channel numbers, each subband is reshaped by their own upsampling modules to get different spatial resolutions, the subbands of different sizes are fed to a four-step inverse transformation in wavelet-like module.

Clause 149. The method of Clause 1, wherein an input feature is processed with 4 individual branch to obtain 4 group information depending on their spatial resolution, and upsampling modules comprise an upsampling module with a single residual block and an upsampling module with a single residual block followed by a residual block with stride.

Clause 150. The method of Clause 1, wherein after quantized latent samples are obtained, the quantized latent samples are fed to a merge and decorrelation block that comprises one or more of a residual block, an attention block or a convolution layer.

Clause 151. The method of Clause 150, wherein the up-transformation module comprises a single residual block, an attention block, or a convolution layer with kernel size being 3 and stride 1.

Clause 152. The method of Clause 1, wherein the visual data is processed by the wavelet-based transform module and transformed to a predetermined number of subbands of four different spatial resolutions, each subband is reshaped by upsampling modules to get a same target size, all subbands go through a merging and decorrelation module, processed latent features are encoded by an entropy encoding module to obtain the bitstream.

Clause 153. The method of Clause 1, wherein an input feature is processed with individual branchs to obtain 4 group information depending on their spatial resolution.

Clause 154. The method of Clause 153, wherein an upsampling module comprises an upsampling block with a subpixel layer followed by leaky ReLU layer.

Clause 155. The method of Clause 1, wherein after all subbands are processed to a same spatial resolution, the processed subbands are fed to a merge and decorrelation block that comprises one or more of a residual block, an attention block or a convolution layer, and wherein the merge and decorrelation module comprises a single residual block, an attention block, a convolution layer with kernel size being 3 and stride 1, and a downsampling module with a single residual block followed by a residual block with stride.

Clause 156. The method of Clause 1, wherein in a decoding process, the bitstream is decoded by an entropy decoding module and a quantized latent representation is obtained by obtaining its samples, the latent representation is processed by inverse transformation to exact feature and increase channel number, the latent feature is then split to a predetermined number subbans for different channel numbers, each subband is reshaped by their own downsampling modules to get different spatial resolutions, the subbands of different sizes are fed to a four-step inverse transformation in wavelet-like module.

Clause 157. The method of Clause 1, wherein an input feature is processed with 4 individual branch to obtain 4 group information depending on their channel number, and dowmsampling modules comprise a dowmsampling module with a single convolution layer and leaky ReLU.

Clause 158. The method of Clause 1, wherein after quantized latent samples are obtained, the quantized latent samples are fed to a transformation block that comprises one or more of a residual block, an attention block or a convolution layer.

Clause 159. The method of Clause 158, wherein the up-transformation module comprises a single residual block, an attention block, or a convolution layer with kernel size being 3 and stride 1.

Clause 160. The method of Clause 1, wherein a neural network structure comprises an attention block, a residual downsample block, a residual unit, a residual block and a residual upsample block.

Clause 161. The method of Clause 160, wherein the residual block comprises convolution layers, a leaky ReLU and a residual connection.

Clause 162. The method of Clause 160, wherein based on the residual block, another ReLU layer is added to the residual unit to get a final output.

Clause 163. The method of Clause 160, wherein the attention block comprises two branches and a residual connection.

Clause 164. The method of Clause 163, wherein the two branches have a residual unit and a convolution layer.

Clause 165. The method of Clause 160, wherein the residual downsample block comprises a convolution layer with stride2, a leaky ReLU, a convolution layer with stride 1, and a generalized divisive normalization (GDN).

Clause 166. The method of Clause 165, wherein the residual downsample block comprises a 2-stride convolution layer in its residual connection.

Clause 167. The method of Clause 160, wherein the residual upsample block comprises a convolution layer with stride2, a leaky ReLU, a convolution layer with stride 1, and an inverse generalized divisive normalization (iGDN).

Clause 168. The method of Clause 167, wherein the residual upsample block comprises a 2-stride convolution layer in its residual connection.

Clause 169. The method of any of Clauses 1-168, wherein the conversion includes encoding the visual data into the bitstream.

Clause 170. The method of any of Clauses 1-168, wherein the conversion includes decoding the visual data from the bitstream.

Clause 171. An apparatus for visual data processing comprising a processor and a non-transitory memory with instructions thereon, wherein the instructions upon execution by the processor, cause the processor to perform a method in accordance with any of Clauses 1-170.

Clause 172. A non-transitory computer-readable storage medium storing instructions that cause a processor to perform a method in accordance with any of Clauses 1-170.

Clause 173. A non-transitory computer-readable recording medium storing a bitstream of visual data which is generated by a method performed by an apparatus for visual data processing, wherein the method comprises: determining a wavelet-based transform module and a resizing operation; and generating the bitstream based on the wavelet-based transform module and the resizing operation.

Clause 174. A method for storing a bitstream of visual data, comprising: determining a wavelet-based transform module and a resizing operation; generating the bitstream based on the wavelet-based transform module and the resizing operation; and storing the bitstream in a non-transitory computer-readable recording medium.

### Example Device

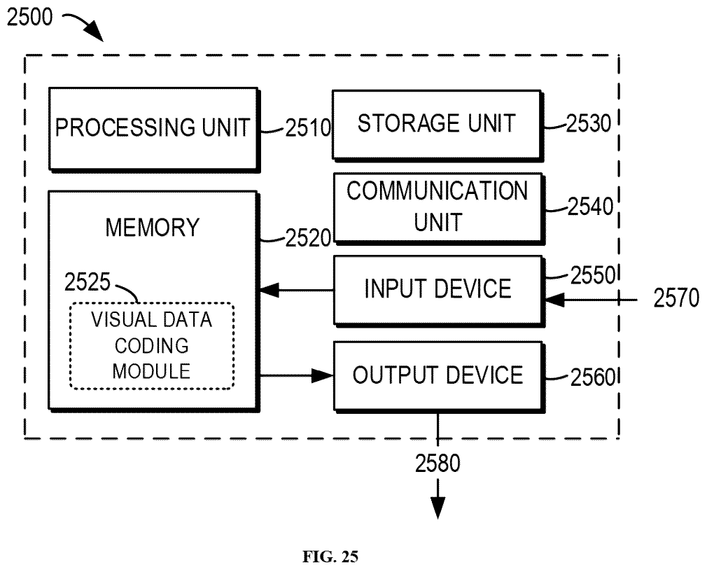

FIG. 25 illustrates a block diagram of a computing device 2500 in which various embodiments of the present disclosure can be implemented. The computing device 2500 may be implemented as or included in the source device 110 (or the visual data encoder 114) or the destination device 120 (or the visual data decoder 124).

It would be appreciated that the computing device 2500 shown in FIG. 25 is merely for purpose of illustration, without suggesting any limitation to the functions and scopes of the embodiments of the present disclosure in any manner.

As shown in FIG. 25, the computing device 2500 includes a general-purpose computing device 2500. The computing device 2500 may at least comprise one or more processors or processing units 2510, a memory 2520, a storage unit 2530, one or more communication units 2540, one or more input devices 2550, and one or more output devices 2560.

In some embodiments, the computing device 2500 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 2500 can support any type of interface to a user (such as “wearable” circuitry and the like).

The processing unit 2510 may be a physical or virtual processor and can implement various processes based on programs stored in the memory 2520. In a multi-processor system, multiple processing units execute computer executable instructions in parallel so as to improve the parallel processing capability of the computing device 2500. The processing unit 2510 may also be referred to as a central processing unit (CPU), a microprocessor, a controller or a microcontroller.

The computing device 2500 typically includes various computer storage medium. Such medium can be any medium accessible by the computing device 2500, including, but not limited to, volatile and non-volatile medium, or detachable and non-detachable medium. The memory 2520 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 2530 may be any detachable or non-detachable medium and may include a machine-readable medium such as a memory, flash memory drive, magnetic disk or another other media, which can be used for storing information and/or visual data and can be accessed in the computing device 2500.

The computing device 2500 may further include additional detachable/non-detachable, volatile/non-volatile memory medium. Although not shown in FIG. 25, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more visual data medium interfaces.

The communication unit 2540 communicates with a further computing device via the communication medium. In addition, the functions of the components in the computing device 2500 can be implemented by a single computing cluster or multiple computing machines that can communicate via communication connections. Therefore, the computing device 2500 can operate in a networked environment using a logical connection with one or more other servers, networked personal computers (PCs) or further general network nodes.

The input device 2550 may be one or more of a variety of input devices, such as a mouse, keyboard, tracking ball, voice-input device, and the like. The output device 2560 may be one or more of a variety of output devices, such as a display, loudspeaker, printer, and the like. By means of the communication unit 2540, the computing device 2500 can further communicate with one or more external devices (not shown) such as the storage devices and display device, with one or more devices enabling the user to interact with the computing device 2500, or any devices (such as a network card, a modem and the like) enabling the computing device 2500 to communicate with one or more other computing devices, if required. Such communication can be performed via input/output (I/O) interfaces (not shown).

In some embodiments, instead of being integrated in a single device, some or all components of the computing device 2500 may also be arranged in cloud computing architecture. In the cloud computing architecture, the components may be provided remotely and work together to implement the functionalities described in the present disclosure. In some embodiments, cloud computing provides computing, software, visual data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding visual data may be stored on a server at a remote position. The computing resources in the cloud computing environment may be merged or distributed at locations in a remote visual data center. Cloud computing infrastructures may provide the services through a shared visual data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 2500 may be used to implement visual data encoding/decoding in embodiments of the present disclosure. The memory 2520 may include one or more visual data coding modules 2525 having one or more program instructions. These modules are accessible and executable by the processing unit 2510 to perform the functionalities of the various embodiments described herein.

In the example embodiments of performing visual data encoding, the input device 2550 may receive visual data as an input 2570 to be encoded. The visual data may be processed, for example, by the visual data coding module 2525, to generate an encoded bitstream. The encoded bitstream may be provided via the output device 2560 as an output 2580.

In the example embodiments of performing visual data decoding, the input device 2550 may receive an encoded bitstream as the input 2570. The encoded bitstream may be processed, for example, by the visual data coding module 2525, to generate decoded visual data. The decoded visual data may be provided via the output device 2560 as the output 2580.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for video processing, comprising:
determining, for a conversion between a visual data and a bitstream of the visual data, a wavelet-based transform module and a resizing operation; and
performing the conversion based on the wavelet-based transform module and the resizing operation.

2. The method of claim 1, wherein performing the conversion comprises:
obtaining a plurality subbands of the visual data transforming the visual data using the wavelet-based transform module;
applying the resizing operation to at least one subband of the plurality of subbands; and
obtaining the bitstream by applying an entropy coding to the plurality of subbands after the resizing operation; or
wherein performing the conversion comprises:
obtaining a plurality subbands of the visual data by applying an entropy decoding to the bitstream;
applying the resizing operation to at least one subband of the plurality of subbands; and
applying a transforming operation on the plurality of subbands after the resizing operation using the wavelet-based transform module.

3. The method of claim 2, wherein sizes of the plurality of subbands comprise one of:
$$\frac{W}{2} \times \frac{H}{2} and \frac{W}{4} \times \frac{H}{4} , or$$
$$\frac{W}{2} \times \frac{H}{2} \frac{W}{4} \times \frac{H}{4} , and \frac{W}{8} \times \frac{H}{8} , or$$
$$\frac{W}{2} \times \frac{H}{2} \frac{W}{4} \times \frac{H}{4} , \frac{W}{8} \times \frac{H}{8} and , \frac{W}{16} \times \frac{H}{16} , and$$
wherein H and W relate to a size of the visual data or a reconstructed visual data, and the number of subbands is dependent on transformation times of the wavelet.

4. The method of claim 3, wherein H is a height of the visual data or the reconstructed visual data, and/or
wherein W is a width of the input visual data or the reconstructed visual data.

5. The method of claim 1, wherein the resizing operation comprises a downsampling or an upsampling operation, and/or
wherein the resizing operation comprises a downsampling operation in an encoder and an upsampling operation in a decoder, and/or
wherein the resizing operation comprises an upsampling operation in an encoder and a downsampling operation in a decoder, and/or
wherein the resizing operation is performed on a subset of the plurality of subbands, or
wherein the resizing operation is performed on all subbands of the plurality of subbands, and/or
wherein the resizing is performed on a subset of the plurality of subbands for a plurality of times by using different resizing operation, and/or
wherein different resizing operations are performed on different subbands, and/or
wherein a subset of subbands of the plurality of subbands are combined in channel dimension before a processing of the resizing.

6. The method of claim 1, wherein the resizing operation is performed by a neural network.

7. The method of claim 6, wherein the neural network used to perform the resizing operation comprises at least one of:
a deconvolution layer,
a convolution layer,
an attention module,
a residual block,
an activation layer,
a leaky rectified linear unit (ReLU) layer,
a ReLU layer, or
a normalization layer.

8. The method of claim 1, wherein the resizing operation is performed according to a target size, and/or
wherein obtaining the plurality of subbands by applying the entropy decoding on the bitstream comprises at least one of:
obtaining a latent representation by applying the entropy decoding to the bitstream; or
dividing the latent representation into at least two divisions, wherein a first division is corresponding to a first subband of the plurality of subbands, and a second division is corresponding to a second subband of the plurality of subbands.

9. The method of claim 8, wherein the target size is equal to a size of a biggest subband, or
wherein the target size is equal to a size of a smallest subband, or
wherein the target size is equal to
$$\frac{W}{2} \times \frac{H}{2} , or \frac{W}{4} \times \frac{H}{4} , or \frac{W}{8} \times \frac{H}{8} , or \frac{W}{16} \times \frac{H}{16} ,$$
wherein H and W relate to a size of the visual data or a reconstructed visual data, and/or
wherein the division of the latent representation is channel wise, or in dimension of feature maps, and/or
wherein a size of the latent representation is C, W and H, wherein W represents a width, H represents a height, and C represents number of channels or number of feature maps, and/or
wherein the latent representation is divided into predetermined number of channels.

10. The method of claim 1, wherein obtaining the bitstream by applying the entropy coding to the plurality of subbands after the resizing operation comprises:
concatenating the plurality of subbands into a latent representation, and/or
wherein if N levels of wavelet-like forward transformations are applied to the visual data, a group of subbands with N spatial sizes are generated, N downsampling modules with different downsampling factors are used to process the group of subbands, and the N downsampling modules are used to unify all subbands in spatial dimensions, wherein N is an integer number, and/or
wherein subbands with smaller sizes than other subbands in the plurality of subbands are resized by upsampling module to a largest spatial resolution, and/or
wherein subbands with larger sizes than other subbands in the plurality of subbands are resized by downsampling module to a smallest spatial resolution.

11. The method of claim 10, wherein the concatenation is performed in channel dimension, wherein if sizes of a first subband and a subband after resizing are C1, H, W and C2, H, W respectively, a size of the latent representation is C1+C2, H, W, and/or
wherein for subbands that obtained after the wavelet tranformation, all subbands are put together though the resizing operation, and/or
wherein the numbers of channels remain unchanged during the resizing operation, and the number of output feature map channels of the resized subbands are (9, 9, 9, 12), and/or
wherein the numbers of channels increase during the resizing operation, and the number of output feature map channels of the resized subbands are (16, 16, 16, 32), and/or
wherein the numbers of channels increase with a ratio of downsampling, and the number of output channels of the resized subbands comprises an incremental sequence corresponding to a size of input subbands, and/or
wherein output channel numbers of first and second largest subbands are reduced, and/or
wherein output channel numbers of smaller subbands are increased while output channel numbers of lager subbands are reduced, and/or
wherein another approach is to process the plurality of subbands by a descending order of their sizes where a largest subband, after first go through an embedding model and downsampling module, is combined with an embedded second largest subband and fed to a next downsampling module, an ultimate module remove a correlation in channel dimension and modify channel number.

12. The method of claim 1, wherein for a latent feature that obtained after the entropy coding, all subbands are reconstructed though the resizing operation, the latent feature are firstly processed by non-linear up-transformation and split to different subbands in channel dimension and then goes through corresponding upsampling modules, and/or
wherein the visual data is processed by the wavelet-based transform module and transformed to a predetermined number of subbands of four different spatial resolutions, each subband is reshaped by their own downsampling modules to get a same target size, all subbands go through a merging and decorrelation module, and processed latent features are encoded by an entropy encoding module to obtain the bitstream, and/or
wherein an input feature is processed with 4 individual branch to obtain 4 group information depending on their spatial resolution, and downsampling modules comprise a downsampling module with a single residual block and a downsampling module with a single residual block followed by a residual block with stride, and/or
wherein the visual data is processed by the wavelet-based transform module and transformed to a predetermined number of subbands of four different spatial resolutions, each subband is reshaped by upsampling modules to get a same target size, all subbands go through a merging and decorrelation module, processed latent features are encoded by an entropy encoding module to obtain the bitstream, and/or
wherein after all subbands are processed to a same spatial resolution, the processed subbands are fed to a merge and decorrelation block that comprises one or more of a residual block, an attention block or a convolution layer, and
wherein the merge and decorrelation module comprises a single residual block, an attention block, a convolution layer with kernel size being 3 and stride 1, and a downsampling module with a single residual block followed by a residual block with stride, and/or
wherein in a decoding process, the bitstream is decoded by an entropy decoding module and a quantized latent representation is obtained by obtaining its samples, the latent representation is processed by inverse transformation to exact feature and increase channel number, the latent feature is then split to a predetermined number subbans for different channel numbers, each subband is reshaped by their own downsampling modules to get different spatial resolutions, the subbands of different sizes are fed to a four-step inverse transformation in wavelet-like module, and/or
wherein an input feature is processed with 4 individual branch to obtain 4 group information depending on their channel number, and downsampling modules comprise a downsampling module with a single convolution layer and leaky ReLU.

13. The method of claim 1, wherein a downsampling module is used in resizing operation in decoder, and/or
wherein an upsampling module is used in a resizing operation in decoder.

14. The method of claim 13, wherein the numbers of channels remain unchanged during the resizing operation, and output channel numbers of downsampling module are (9, 9, 9, 12), and/or
wherein the numbers of channels remain unchanged during the resizing operation, and output channel numbers of different downsampling modules are different, and/or
wherein the numbers of channels increase with a ratio of upsampling, and the number of output channels of the resized subbands comprises an incremental sequence corresponding to a size of input latent samples, and/or
wherein input channel numbers corresponding to first and second largest subbands are reduced, and/or
wherein input channel numbers corresponding to smaller subbands are increased while input channel numbers of lager subbands are reduced, and/or
wherein another approach is to process the plurality of subbands by a descending order of their sizes where a latent feature first goes through an upsampling module and then is split to two parts, the following operation is repeated till all subbands are reconstructed: a bigger part is fed to a next upsampling module while a smaller part becomes a subband after the resize operation.

15. The method of claim 1, wherein after all subbands are processed to a same spatial resolution, the processed subbands are fed to a merge and decorrelation block that comprises one or more of a residual block, an attention block or a convolution layer, and/or
wherein in a decoding process, the bitstream is decoded by an entropy decoding module and a quantized latent representation is obtained by obtaining its samples, the latent representation is processed by up-transformation to exact feature and increase channel number, the latent feature is then split to a predetermined number subbans for different channel numbers, each subband is reshaped by their own upsampling modules to get different spatial resolutions, the subbands of different sizes are fed to a four-step inverse transformation in wavelet-like module, and/or
wherein an input feature is processed with 4 individual branch to obtain 4 group information depending on their spatial resolution, and upsampling modules comprise an upsampling module with a single residual block and an upsampling module with a single residual block followed by a residual block with stride, and/or
wherein after quantized latent samples are obtained, the quantized latent samples are fed to a merge and decorrelation block that comprises one or more of a residual block, an attention block or a convolution layer, and/or
wherein an input feature is processed with individual branchs to obtain 4 group information depending on their spatial resolution, and/or
wherein after quantized latent samples are obtained, the quantized latent samples are fed to a transformation block that comprises one or more of a residual block, an attention block or a convolution layer, and/or
wherein a neural network structure comprises an attention block, a residual downsample block, a residual unit, a residual block and a residual upsample block.

16. The method of claim 15, wherein the merge and decorrelation module comprises a single residual block, an attention block, and a convolution layer with kernel size being 3 and stride 1, and/or
wherein the up-transformation module comprises a single residual block, an attention block, or a convolution layer with kernel size being 3 and stride 1, and/or
wherein an upsampling module comprises an upsampling block with a subpixel layer followed by leaky ReLU layer, and/or
wherein the up-transformation module comprises a single residual block, an attention block, or a convolution layer with kernel size being 3 and stride 1, and/or
wherein the residual block comprises convolution layers, a leaky ReLU and a residual connection, and/or
wherein based on the residual block, another ReLU layer is added to the residual unit to get a final output, and/or
wherein the attention block comprises two branches and a residual connection, and/or
wherein the residual downsample block comprises a convolution layer with stride2, a leaky ReLU, a convolution layer with stride 1, and a generalized divisive normalization (GDN), and/or
wherein the residual upsample block comprises a convolution layer with stride2, a leaky ReLU, a convolution layer with stride 1, and an inverse generalized divisive normalization (iGDN).

17. The method of claim 1, wherein the conversion includes encoding the visual data into the bitstream, or
wherein the conversion includes decoding the visual data from the bitstream.

18. An apparatus for visual data processing comprising a processor and a non-transitory memory with instructions thereon, wherein the instructions upon execution by the processor, cause the processor to perform a method comprising:
determining, for a conversion between a visual data and a bitstream of the visual data, a wavelet-based transform module and a resizing operation; and
performing the conversion based on the wavelet-based transform module and the resizing operation.

19. A non-transitory computer-readable storage medium storing instructions that cause a processor to perform a method comprising:
determining, for a conversion between a visual data and a bitstream of the visual data, a wavelet-based transform module and a resizing operation; and
performing the conversion based on the wavelet-based transform module and the resizing operation.

20. A non-transitory computer-readable recording medium storing a bitstream of visual data which is generated by a method performed by an apparatus for visual data processing, wherein the method comprises:
determining a wavelet-based transform module and a resizing operation; and
generating the bitstream based on the wavelet-based transform module and the resizing operation.
